(19) United States
(12) Patent Application Publication
(10) Pub. No.: US 2012/0290506 A1
(43) Pub. Date: Nov. 15, 2012

(54) VEHICULAR NAVIGATION APPARATUS

(75) Inventors: Satoru MURAMATSU, Kariya-city (JP); Yoshiyuki Matsubara, Nagoya-city (JP)

(73) Assignee: DENSO CORPORATION, Kariya-city (JP)

(21) Appl. No.: 13/466,206

(22) Filed: May 8, 2012

(30) Foreign Application Priority Data
May 9, 2011 (JP) 2011-104281
Nov. 11, 2011 (JP) 2011-247510

(51) Int. Cl. G01C 21/00; G06F 17/00

(52) U.S. Cl. 705/412; 701/400

(57) ABSTRACT

A vehicular navigation apparatus includes a control unit that sets a reachable area that is reachable by a vehicle, such that a remaining charge amount of a battery of the vehicle has a remaining charge amount above a quick charge threshold at the reachable area. The quick charge threshold is provided as a charge level of the battery that is required for a quick charge operation of the battery. The control unit further searches for a battery charge spot in the reachable area, and provides guidance to the battery charge spot. The control unit may further redefine the reachable area where a charge operation is scheduled, based on preferences provided by a user.

### CROSS-REFERENCE TO RELATED APPLICATION

This application is based on and claims the benefit of priority of Japanese Patent Application No. 2011-104281 filed on May 9, 2011 and Japanese Patent Application No. 2011-247510 filed on Nov. 11, 2011, the disclosure of which is incorporated herein by reference.

### TECHNICAL FIELD

The present disclosure generally relates to a vehicular navigation apparatus for an automobile such as a hybrid vehicle, a battery vehicle or the like.

### BACKGROUND

In recent years, the development and availability of hybrid and battery vehicles has increased, since they emit less pollutants and are more energy efficient than gasoline vehicles. Some hybrid and battery vehicles are equipped with environmental-friendly features, as disclosed in, for example, Japanese Patent Laid-Open No. 2008-247317 (JP '317). According to JP '317, effectiveness of saving fuel of the hybrid vehicle is notified to a user of a hybrid vehicle by a technique of JP '317, and such technique enables promotion of the ecology-friendliness/consciousness and understanding of the user for fuel saving.

In addition, route guidance techniques are also a focus of recent technical development. That is, in gasoline vehicles, the vehicular navigation apparatus reminds the user of the remaining amount of gasoline in a gasoline tank and location information of gas stations. A similar method may be implemented in terms of when and where to charge a battery for a hybrid and/or a battery vehicle. However, two major differences between charging a battery versus re-fueling a gasoline tank are recognized.

First, charging a battery takes a significantly longer time, in comparison to re-fueling. The long charge time at an in-route charge spot may, for example, substantially affect the itinerary of a long trip. That is, the user has to be well-prepared for and has to determine in advance where to charge the battery.

Secondly, the wear of the battery is different depending on the battery type and how the battery is charged. The battery is substantially and quickly worn out when the user frequently uses a quick charge. When the battery is quickly worn out, the user has to buy and replace an expensive battery very frequently, which imposes a very high cost on the user.

Similar relevant technical thoughts are also disclosed in the following patent documents: Japanese Patent Laid-Open No. 2009-8609, Japanese Patent Laid-Open No. 2009-136109, Japanese Patent Laid-Open No. 2010-101854, Japanese Patent No. 3900993, and Japanese Patent Laid-Open No. H10-170293.

### SUMMARY

In an aspect of the present disclosure, the vehicular navigation includes a first area setting unit, a battery charge spot search unit, and a battery charge spot guidance unit. The first area setting unit determines a reachable area that is reachable by the vehicle such that a battery of the vehicle has a remaining charge amount that is equal to or above a quick charge threshold within the reachable area. The quick charge threshold is the recommended charge amount for a battery in order for a quick charge operation to be performed, so that the life of the battery may not be harmed by the quick charge operation.

The battery charge spot search unit searches the reachable area that is set by the first area setting unit for a battery charge spot, and the battery charge spot guidance unit guides the user to the battery charge spot provided by the battery charge spot search unit. Accordingly, the user is guided to a battery charge spot and may charge the battery with a quick charge operation without deteriorating the life of the battery, since the remaining charge amount of the battery is equal to or greater than the quick charge threshold.

The apparatus may also include a route finding unit for determining a route to a destination from a departure place, and a charge count unit for counting the number of battery charge operations that are needed along the route. Further, the first area setting unit sets a plurality of reachable areas that minimizes the number of battery charge operations when the number of battery charge operations along the route is greater than one. In such manner, the apparatus provides appropriate battery charge spots while reducing the number of battery charge operations.

In addition, when the first area setting unit sets the plurality of reachable areas, by determining a first battery charge spot in a first departure-side reachable area and assuming a full charge of the battery at the first battery charge spot, the first area setting unit determines a first destination-side reachable area as a next reachable area, which is reachable by the full charge of the battery at the first battery charge spot. Also, by recognizing that the battery charge spot is not found in the first destination-side reachable area and assuming a full charge of the battery at a second battery charge spot, which is on a destination side of the first battery charge spot in the first departure-side area, the first area setting unit repeats an area setting process for setting a second destination-side reachable area on a destination side of the second battery charge spot, the second destination-side reachable area replacing the first destination-side reachable area.

In other words, in a course of setting the plurality of reachable areas, even when a first search for finding a battery charge spot in an area closer to the destination could not find any battery charge spot after finding the first battery charge spot in the first departure-side reachable area, repeated searches for finding the second battery charge spot in the second reachable area on a destination side of the first battery charge spot are conducted until finding a battery charge spot in the second reachable area. Therefore, an area where the battery of the vehicle cannot be charged will not be set between the departure place and the destination.

According to the present disclosure, after the route via the battery charge spots from the departure place to the destination is determined, a determination unit determines in real time whether the “next” battery charge spot is reachable by consuming the remaining charge amount of the battery while the vehicle is traveling (i.e. real time remaining charge amount). A search repeat unit re-calculates the route and re-searches for the battery charge spots when the “next” battery charge spot is determined as un-reachable. In such manner, the battery charge spot will be searched for again and the charge of the batter is prevented from reaching zero.

According to the present disclosure, a second area setting unit is provided for setting a maxima area where the vehicle is reachable with the remaining charge amount of the battery decreases substantially to zero, and the battery charge spot search unit searches for a battery charge spot in the maxima area that is set by the second area setting unit. Further, the guidance unit guides the vehicle to each of the battery charge spots that are searched for by the battery charge spot search unit and that exist in the areas respectively set by the first and second area setting units. In such manner, the number of available battery charge spot increases.

In addition, the battery charge spot search unit temporarily sets a pre-defined value of a break time for a battery charge spot to be used as a permissible wait time at the battery charge spot. The permissible wait time is compared with a full charge time to determine whether the full charge time at the battery charge spot exceeds the permissible wait time for the battery charge spot. The full charge time is the amount of time needed to bring the battery to a full charge at the battery charge spot. When the full charge time exceeds the permissible wait time, the battery charge spot search unit searches for a different charge spot. In such manner, the battery may be charged within a break time, or within a permissible wait time.

The battery charge spot search unit may temporarily set a pre-defined value of a break time that is pre-defined for a battery charge spot to be used as a pre-defined charge time at the battery charge spot. The battery charge spot search unit calculates a departing charge amount of the battery at a time of departure from the battery charge spot by (i) subtracting, from the remaining charge amount, a required power amount for the travel of the vehicle to the searched battery charge spot and (ii) adding, a charge amount received during the pre-defined charge time at the battery charge spot. If the departing charge amount is equal to or greater than a predetermined amount, the battery charge spot is set as the next battery charge spot. In such manner, the remaining charge amount of the battery is maintained above the predetermined level, thereby lightening the battery load and extending the battery life.

The battery charge spot search unit may also determine whether a battery charge spot is congested. When the battery charge spot is determined as congested, the battery charge spot search unit searches for a different battery charge spot. In such manner, the user may charge the battery at a battery charge spot that best satisfies an expectation of the user's.

The battery charge spot search unit may also determine whether a charge start wait time of a battery charge spot exceeds a permissible wait time. When the charge start wait time exceeds the permissible wait time, the battery charge spot search unit searches for a different battery charge spot. In such manner, a battery charge spot that has a charge start wait time equal to or less than the permissible wait time is provided.

The apparatus may also include a reserve unit to set a charge reservation by utilizing reservation information of a charge apparatus of a battery charge spot that is searched by the battery charge spot search unit. Therefore, the reserve unit can arrange a smooth charge operation. More practically, even if the battery charge spot is congested at the time of making the charge reservation, congestion at the battery charge spot may be resolved before the arrival of the vehicle, thereby providing a smooth start of the charge operation of the battery.

The apparatus may also include a third area setting unit for setting an intermediate reachable area that is in middle of a plurality of reachable areas. The third area setting unit may determine the intermediate reachable area according to a priority level of a user preference, and the battery charge spot search unit searches for a battery charge spot in the intermediate area according to the priority level of the user preference. In such manner, a battery charge spot that best satisfies the user's request or preference is provided.

The apparatus may also include a cost calculation unit for calculating a cost of charging the battery to a full charge at respective battery charge spots based on an expected remaining charge amount of the battery at a time of arriving at the respective battery charge spots. A notification control unit may control a notification unit to present a list of full charge costs at the respective battery charge spots. In such manner, the user may recognize the cost of charging at the battery charge spots.

The notification control unit may also control the notification unit to present discount information of the cost in the list of full charge costs when a discount is available for the cost that is calculated by the cost calculation unit. The notification control unit may also control the notification unit to present charge time information of the respective battery charge spots in a list that shows correspondence between the battery charge spots and the costs.

### BRIEF DESCRIPTION OF THE DRAWINGS

Other objects, features and advantages of the present invention will become more apparent from the following detailed description disposed with reference to the accompanying drawings, in which:

FIG. 1 is a block diagram of a circuit configuration of a vehicular navigation apparatus of the present disclosure;

FIG. 2 is a flowchart of a route guidance process;

FIG. 3 is an illustration of a display screen of a user setting interface in a first embodiment of the present disclosure;

FIG. 4 is a flowchart of a charge spot list making method with consideration of battery life;

FIG. 5 is a flowchart of the charge spot list making method with consideration of travel time of a vehicle;

FIGS. 6A and 6B are illustrations of the determination process of FIG. 5;

FIG. 7 is a charge spot list making method with consideration of travel time of a vehicle;

FIGS. 8A and 8B are illustrations of the determination process of FIG. 7;

FIG. 9 is a flowchart of a charge spot list making method with consideration of charge cost of the present disclosure;

FIG. 10 is a flowchart of a charge spot list making method with consideration of charge start time of the present disclosure;

FIGS. 11A and 11B are examples of a charge spot selection screen of the present disclosure;

FIG. 12A is an illustration of a charge spot selection screen of the present disclosure;

FIG. 12B is an illustration of a map of the charge spot selected in FIG. 12A;

FIG. 13 is a flowchart of a charge amount determination process of the present disclosure;

FIG. 14 is an illustration of the display screen of the user setting interface in a second embodiment of the present disclosure;

FIG. 15 is a flowchart of a control operation in consideration of priority levels of user preferences of the second embodiment of the present disclosure;

FIG. 16 is an illustration of reachable areas of the second embodiment of the present disclosure;

FIG. 17 is an illustration of the display screen of the user setting interface in a third embodiment of the present disclosure;

FIG. 18 is an illustration of the display screen of the user setting interface of the third embodiment of the present disclosure;

FIG. 19 is a flowchart of a control operation with consideration of charge wait time of the third embodiment of the present disclosure;

FIG. 20 is an illustration of various break time settings of the third embodiment of the present disclosure;

FIG. 21 is a diagram of time-wise change of a travel distance and a remaining charge amount of a route plan having a considerable amount of charge wait time of the third embodiment of the present disclosure;

FIG. 22 is a diagram of time-wise change of a travel distance and a remaining charge amount of a route plan having no charge wait time of the third embodiment of the present disclosure;

FIG. 23 is a flowchart of a control operation of planning a route which gives a top priority to the charge wait time;

FIG. 24 is an illustration of a route determination for a charge wait time consideration process of the third embodiment of the present disclosure;

FIG. 25 is an illustration of charge spots for an area Aa of FIG. 24,

FIG. 26 is an illustration of the route determination for the charge wait time consideration as based on FIG. 24;

FIG. 27 is a diagram of time-wise change of the travel distance and the remaining charge amount of the route plan of FIG. 26;

FIG. 28 is an illustration of the route determination for the charge wait time consideration based on FIG. 27;

FIG. 29 is an illustration of the route determination for the charge wait time consideration based on FIG. 28;

FIG. 30 is an illustration of a congestion prediction for a charge device congestion prediction consideration of the third embodiment of the present disclosure;

FIG. 31 is a diagram of time-wise change of the travel distance and the remaining charge amount of a route plan of the third embodiment of the present disclosure; and

FIG. 32 is a diagram of time-wise change of the travel distance and the remaining charge amount of a route plan of the third embodiment of the present disclosure.

### DETAILED DESCRIPTION

### First Embodiment

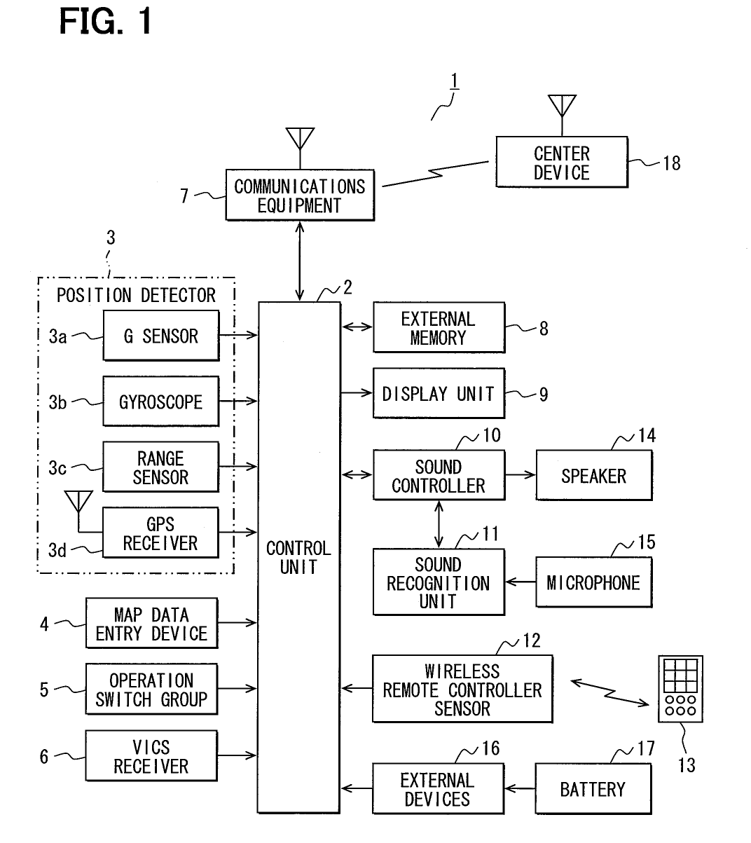

The first embodiment of the present disclosure is described as follows with reference to FIG. 1-FIG. 13.

FIG. 1 shows a circuit configuration block diagram of a vehicular navigation apparatus 1. The vehicular navigation apparatus 1 has a control unit 2 that is coupled respectively to a position detector 3, a map data entry device 4, an operation switch group 5, a Vehicle Information Communication System (VICS) (a registered trademark) receiver 6, a communications equipment 7, an external memory 8, a display unit 9, a sound controller 10, a sound recognition unit 11, and a wireless remote controller sensor 12.

The wireless remote controller sensor 12 is coupled to a wireless remote controller 13 through infra-red connection, the sound controller 10 is coupled to a speaker 14, and the sound recognition unit 11 is coupled to a microphone 15. Further, external devices 16 are coupled to the control unit 2.

The control unit 2 includes a microcomputer as a main component, and thus includes a CPU, a RAM, a ROM, and an input/output bus (none shown). The control unit 2 performs various control programs and control operations of the entire navigation apparatus. The control unit 2 enables each of software-implemented functions of the present disclosures, such as a first area setting unit, a battery charge spot search unit, a battery charge spot guidance unit, a route search unit, a charge count unit, a determination unit, a re-search unit, a second area setting unit, a third area setting unit, a cost calculation unit, a notification control unit and a reservation unit.

The position detector 3 has a G sensor 3a, a gyroscope 3b, a range sensor 3c, a GPS receiver 3d and the like. The control unit 2 uses signals of the sensors to determine a current position of the vehicle based on mutual interpolation and correction of the signals from the sensors. If the required accuracy of the vehicle position is determined without using all of the signals, some of the sensors may be omitted from the position detector 3. Further, other sensors, such as a steering rotation angle sensor and a tire sensor, may also be used for determining the vehicle position.

The map data entry device 4 has recording media such as a CD-ROM, a DVD-ROM, a memory card, or a hard disk drive (i.e., HDD), and inputs various data for map display, map matching, and the like. The operation switch group 5 includes mechanical keys around the display unit 9 and touch keys on a display screen of the display unit 9, and outputs to the control unit 2 operation detection signals when, for example, it detects a user operation/instruction such as a menu choice, a destination setting, a route search, a route guidance start, a screen change, a volume adjustment, and the like.

The VICS receiver 6 performs communication through a wide area communications network, and receives VICS information transmitted by a VICS center device (not illustrated) through the wide area communications network. The communications equipment 7 is a device to perform communication with a center device 18 installed on a road, exchanging various kinds of data with external devices and/or apparatuses. The external memory 8 includes a mass storage such as HDD or the like. Though the current disclosure provides that the vehicular navigation apparatus 1 is coupled to VICS, which is a specific technology employed in Japan for delivering traffic and travel information to road vehicle drivers, the present disclosure may also be adapted to other traffic and travel information delivery systems, such as Traffic Message Channel (TMC) which is used in Europe.

The display unit 9 is a device, such as a color liquid crystal display or the like, and displays various display screens, such as a menu choice screen, a destination setting screen, a route guidance screen, and the like. The display unit 9 also displays a current position and a travel locus of the vehicle as a marking on the map. The display unit 9 may also be an organic electroluminescence display device or a plasma display device.

The sound controller 10 outputs, for example, a beep sound of an alarm and/or a guidance sound/voice of the route guidance from the speaker 14. The sound recognition unit 11 is controlled by the control unit 2, and recognizes sound/voice, which is received from the microphone 15, by using a sound recognition algorithm. The wireless remote controller sensor 12 receives an operation detection signal transmitted from the wireless remote controller 13, and outputs the received operation detection signal to the control unit 2.

The external devices 16 calculate a charge condition and a continued mileage information of a battery 17, and provides the information to the control unit 2. The control unit 2 has a travelable distance calculation unit. The travelable distance calculation unit receives the charge condition and the continued mileage information of the battery 17, and calculates the travelable distance from the current vehicle position based on the information concerned. The control unit 2 searches for a route based on the above-described information. The calculation process of the charge condition and the continued mileage information of the battery 17 may be performed by using a module disposed in the control unit 2.

The control unit 2 includes a map data acquisition unit for acquiring map data and a map matching unit for identifying a road that is currently traveled by the vehicle based on the current vehicle position and road data in the map data from the map data acquisition unit. In addition the control unit 2 includes a route search unit (i.e., the software-implemented function of the route search unit) for searching for a route from the current vehicle position identified by the map matching unit to a destination that is set by the user and a route guidance unit for calculating guidance points and performing a route guidance based on the route searched for by the route search unit as well as road data and intersection point data in the map data. Furthermore, the control unit 2 includes a display control unit for displaying a map around the current vehicle position as well as a simplified map of expressways and an expanded view of an intersection.

The battery life of the battery 17 may be shortened when the battery 17 has a remaining charge amount less than a predetermined threshold and a quick charge is performed. In other words, to extend the life of the battery 17 only a normal charge (i.e., a normal-speed charge) should be performed when the remaining charge amount is less than a predetermined threshold, such as 20% of full charge. The battery 17 may have a quick charge (i.e., a high-speed charge) when the remaining charge amount is equal to or greater than the predetermined threshold. In the present embodiment, the control unit 2 receives through the external devices 16 the charge condition, the continued mileage information, and the charge amount change/variation information of the battery 17. The control unit 2 calculates the remaining charge amount of the battery 17 and performs a route guidance process. The remaining charge amount is provided as the current charge of the battery 17, which may also be known as the state of charge of the battery 17.

The control unit 2 is communicably coupled to the center device 18 through wired/wireless communication by the communications equipment 7. The center device 18 is disposed outside of the vehicle (i.e. is external to the vehicle), and, for example, includes a computer and a database accumulating various data. The center device 18 performs various calculation processes, based on information in the accumulated data or information transmitted from the control unit 2 in the vehicle, and transmits the information of the accumulated data, calculation process, or data after calculation process to the control unit 2 in the vehicle.

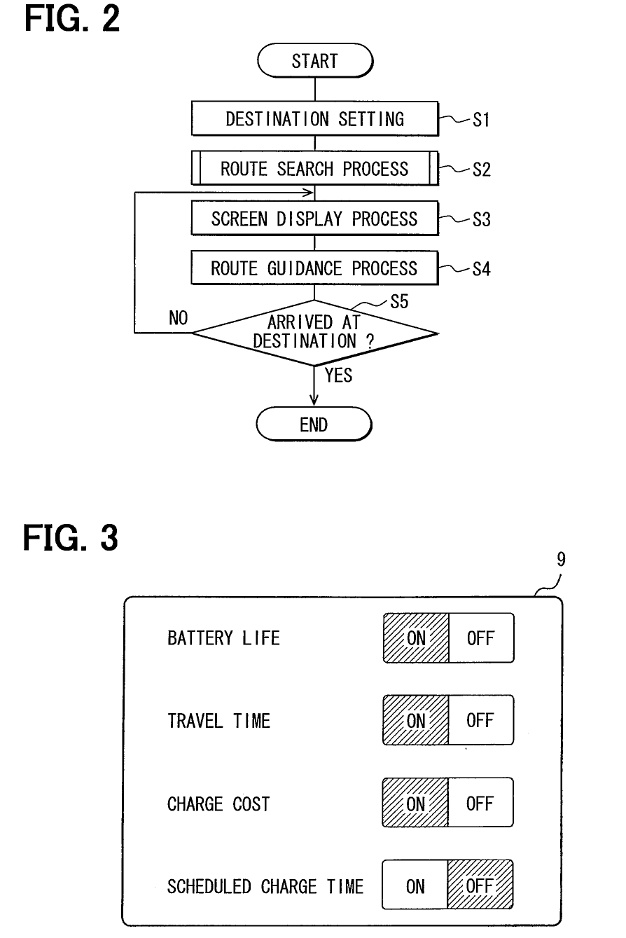

In the present embodiment, a recommended battery charge spot of the battery 17 reflecting various user preferences is provided to the user. FIG. 2 shows a basic operation of the route guidance process. At first, a destination is set by the user via the operation switch group 5 (S1). When the destination is set, the control unit 2 performs a route search process for searching for a route to the destination from the current position (S2). When the route search process is finished, a screen display process (S3) and the route guidance process (S4) are performed until the vehicle arrives at the destination (S5:YES).

FIG. 2 shows provides a normal flow of the route guidance process. By receiving, in the vehicle, the charge condition, a history of the continued mileage information, and the charge amount change information of the battery 17, the control unit 2 can provide a charge warning before the remaining charge amount of the battery 17 is substantially at zero. In the present embodiment, the route search process reflecting various user preferences is performed in S2 besides the charge warning process.

The user may set a battery charge spot and a battery charge timing according to the user's preference, which may be based on, for example, environmental/battery life preservation, time consciousness, and cost consciousness. Such preferences may be provided as the following factors (1)-(4):

(1) battery life consideration (i.e., environmental/battery life preservation)

(2) travel time consideration (i.e., time consciousness (1))

(3) charge cost consideration (i.e., cost consciousness)

(4) scheduled charge time consideration (i.e., time consciousness (2))

Factor (1), battery life consideration, is when the user is conscious of the life of the battery 17. Factor (2), travel time consideration, is when the user values or places importance on a travel time from the departure place (e.g., a current vehicle position) to the destination. Factor (3), charge cost consideration, is when the user considers the cost of the charge operation. Factor (4), scheduled charge time consideration, is when the user values a scheduled charge time, which is similar to factor (2), but is specifically related to a charge start time and a charge end time. Such scheduled charge time may be important when the user tries to charge the battery 17 during a specific task, such as while dining.

With reference to FIG. 3, the control unit 2 displays a selection screen of factors (1)-(4) on the display unit 9 as an initial setting screen. The control unit 2 receives an input from the touch panel (i.e., the operation switch group 5), and sets the necessity of consideration of each of the factors (1)-(4). In such manner, the user is able to identify the factors important to the user, and the navigation apparatus 1 determines and identifies a battery charge spot and a charge timing according to the factors selected by the user.

(1) Battery Life Consideration (Environmental/Battery Life Preservation)

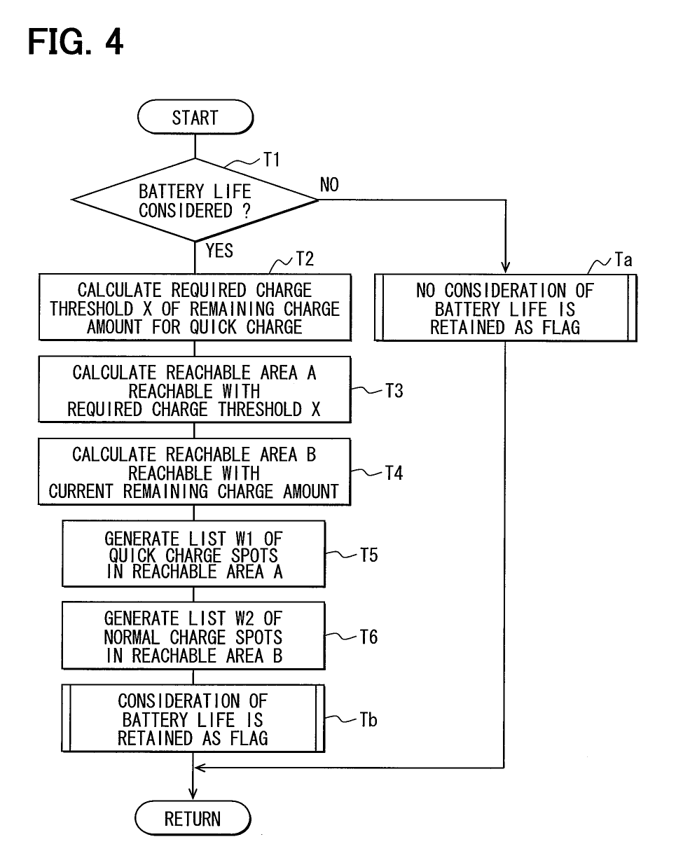

FIG. 4 provides a control of the battery charge operation in a battery life consideration setting (i.e. in consideration of the battery life of the battery 17) when the user sets the battery life as a preference in FIG. 3.

The control unit 2 searches for a basic route from the current vehicle position to the destination by using a Dijkstra method, and performs the following process after the completion of the route search process for searching for the basic route of FIG. 2. The control unit 2 determines whether the battery life consideration of the battery 17 is set by the user in T1, and, if consideration of the life of the battery 17 is not required (T1:NO), the control unit 2 retains as a flag (Ta) that no consideration is required for the life of the battery 17, and returns to a main routine (i.e. the process of FIG. 2). If consideration of the life of the battery 17 is required (T1:YES), T2-T6 are performed.

In T2, a required charge threshold X for recommending a quick charge is determined (i.e. quick charge threshold in claims). Specifically, when the battery 17 has a remaining charge amount less than the required charge threshold X and a quick charge is performed, the life of the battery 17 may diminish at a faster rate than when the quick charge is not used at such a charge state of the battery 17. Therefore, the battery 17 may under go a quick charge when the remaining charge amount of the battery 17 is greater than the required charge threshold X or a predetermined ratio (e.g., 20%). Additionally, the battery 17 may be controlled to have a normal charge when the remaining charge amount is less than the required charge threshold X. For example, the user may be prompted to perform the normal charge or the normal charge may be automatically performed when the remaining charge amount is less than the required charge threshold X.

After having determined the required charge threshold X in T2, the control unit 2 calculates in T3 a reachable area A that can be reached by the vehicle such that the remaining charge amount of the battery 17 is at least equal to the required charge threshold X. Further, the control unit 2 calculates in T4 a maxima area B that can be reached by the vehicle, such that the remaining charge amount of the battery 17 is substantially equal to zero (i.e. the charge of the battery 17 is substantially consumed). Further, the control unit 2 makes and retains in T5 a list W1 of quick charge spots (i.e. charge spots where the quick charge can be performed) in the reachable area A. Further, the control unit 2 makes and retains in T6 a list W2 of normal charge spots (i.e. charge spots where the normal charge can be performed) in the maxima area B.

The control unit 2 can now identify the charge spots in the reachable area A where the quick charge is performable with reference to the list W1, and can now identify the charge spots in the maxima area B where the normal charge is performable with reference to the list W2.

In this case, the list W2 of the charge spots may be a list of all charge spots dispersed in the entire maxima area B, or may be a list of charge spots in the maxima area B but not in the reachable area A. In other words, when the vehicle reaches the non-A area in the maxima area B, the battery 17 needs to be charged by the normal charge if the life of the battery 17 is considered, because, after the travel of the vehicle into a non-A area in the maxima area B, the remaining charge amount of the battery 17 is most likely less than the required charge threshold X.

(2) Travel Time Consideration (Time Consciousness (1))

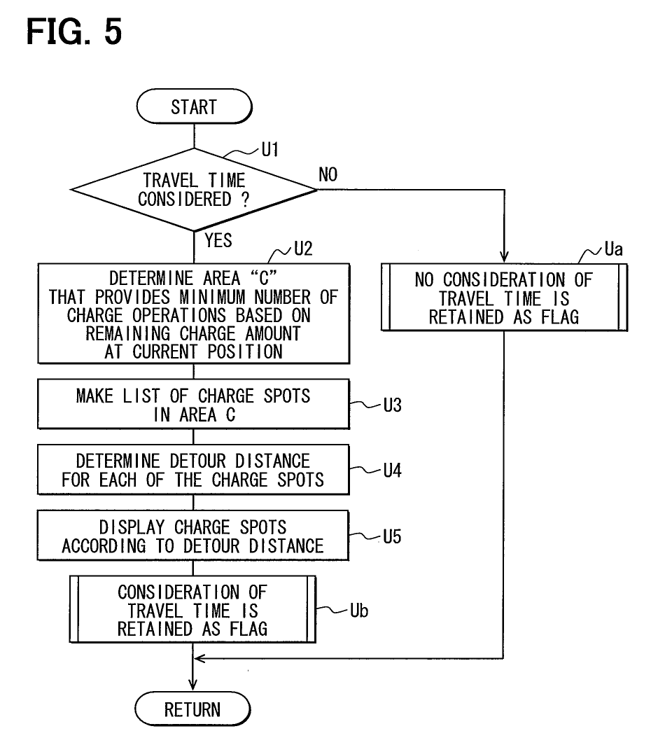

With reference to FIG. 5, a control of the battery charge operation in consideration of the travel time of the vehicle is described. Specifically, when selecting factor (2), travel time consideration, the user of the vehicle places importance on the travel time from the departure place (i.e., the current vehicle position) to the destination.

The control unit 2 determines, in U1, whether travel time consideration (i.e. factor (2)) is set by the user, and if no consideration of travel time is required (U1:NO), the control unit 2 retains as a flag that that no consideration is required for the travel time, and returns to the main routine from the present routine. If consideration of the travel time is required (U1:YES), U2-U5 are performed. The control unit 2 calculates an area C that enables a minimum number of charge operations based on the remaining charge amount at the current vehicle position. The area C is an area that allows the vehicle to arrive at the destination with a minimum number of charge operations if the vehicle travels to the area C and the vehicle is charged in the area C.

When consideration of the travel time is required (U1:YES), the control unit 2, in U2, calculates the area C, which enables the minimum number of charge operations based on the remaining charge amount at the current vehicle position, and, in U3, generates a list of charge spots in the area C. The control unit, in U4, determines a detour distance from the basic route for each of the charge spots. In U5, the display unit 9 provides the charge spots, in a sorted manner according to the detour distance, and consideration of the travel time is retained as a flag (Ub).

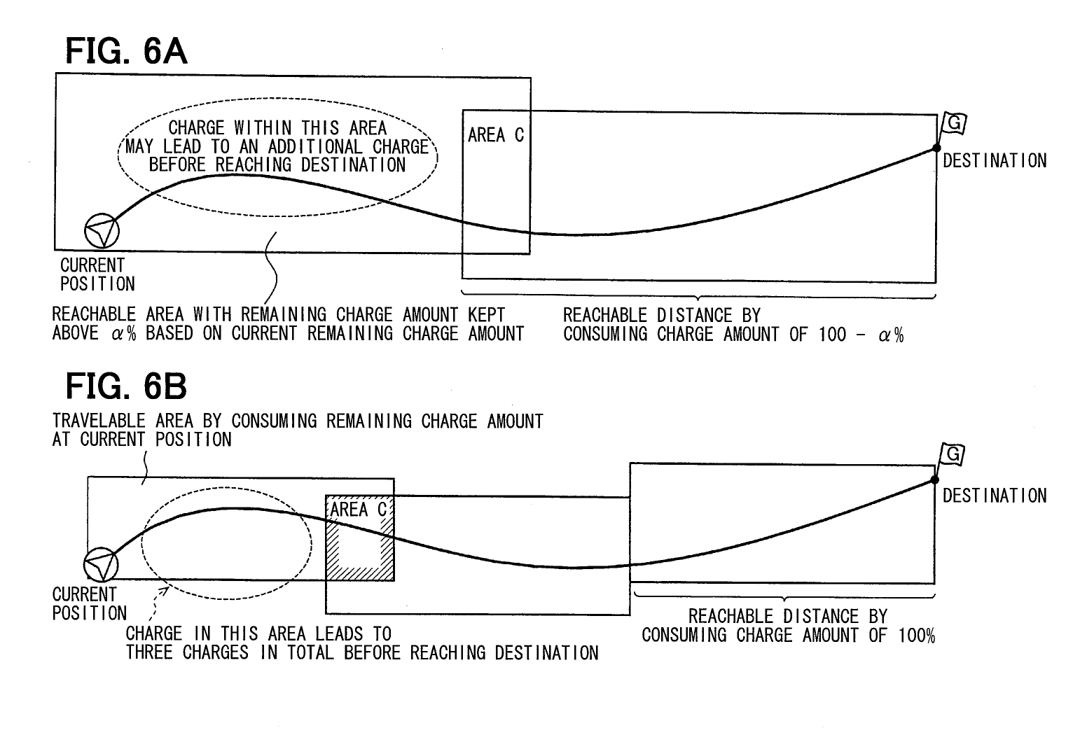

FIG. 6A and FIG. 6B show illustrations of the area C set by the processes in s U2-U4. The number of charge operations for reaching the destination can be calculated in the following manner. When the travelable distance with the remaining charge amount is subtracted from the distance between the current vehicle position and the destination, the remaining distance to the destination is calculated. When the remaining distance is divided by a full-charge travelable distance, which is the distance the vehicle may travel when the battery 17 is fully charged, the minimum number of charge operations is determined.

The example shown in FIG. 6A is a case in which the number of charge operations before reaching the destination from the current position (i.e., the departure place) is determined as 1. In this case, the area C is set at a position that is closer to the destination than the current position (i.e., the departure place). When the charge spot is too close to the current position, an additional charge operation may be needed at a position closer to the destination relative to the charge spot.

The following describes the process of the control unit 2 when factor (2) travel time consideration and factor (1) the battery life consideration are both set. In consideration of the battery life, the remaining charge amount of the battery 17 is provided as a minimum charge level of α %, such that the battery 17 is required to have a remaining charge amount of at least α %, when the vehicle arrives at the destination. The minimum charge level α % corresponds to a ratio of the required charge threshold X for recommending the quick charge when a full charge is designated as 100%. Such a setting is performable by the user through the setting screen shown in FIG. 3.

If the remaining charge amount is provided as, for example, β % at the current vehicle position (assuming β>α), the control unit 2 predicts an area travelable by vehicle till the remaining charge amount is equal to α % in a direction towards the destination from the current vehicle position.

The control unit 2 further determines another area that centers around the destination in which the vehicle, after establishing a full charge of the battery 17, may reach the destination and have a remaining charge amount of at least α %. An overlapping portion of the two areas is set as the area C. If a charge operation is performed before arriving at area C, an additional charge operation would have to be performed again before arriving at the destination. If a charge operation is performed in the area C, the vehicle can reach the destination by only one charge operation with the remaining charge amount kept above α % or above the required charge threshold X.

Therefore, in the example provided, the control unit 2 determines the area C for performing only one charge operation, which is the minimum number of charge operations, before reaching the destination from the current vehicle position, in consideration of the remaining charge amount at the current vehicle position (i.e., the departure place). In other words, as shown in FIG. 6A, if the charge operation can be performed in the area C, which is provided to be closer to the destination relative to the current position, the vehicle can arrive at the destination with the fewest number of charge operations and have a certain charge amount remaining in the battery 17.

Further, the example shown in FIG. 6B is a case in which the number of charge operations before reaching the destination from the current position (i.e., the departure place) is provided as 2 or more. The control unit 2 determines an area that is travelable/reachable with the remaining charge amount of the battery 17 at the current position (i.e. travelable area by consuming the remaining charge amount of the battery 17). Next, the control unit 2 determines another area, which is closer to the destination and is far as possible from the current position, as the area C in which a first charge spot for the first charge operation is provided.

A “second” charge spot for the second charge operation is determined after actually performing the first charge operation, because the position of the first charge spot is not yet determined in the area C. That is, in subsequent U2-U4, the charge spots in the area C are simply kept as a list until after the completion of the first charge operation by the user, and then the process in FIG. 5 is repeated for setting the area that includes the charge spots for the second and subsequent charge operations as required. In other words, by setting the first charge spot first, and then setting the second charge spot and the subsequent charge spots as required, the charge spots are more appropriately determined and provided for the user.

### MODIFICATION EXAMPLE

If the number of charge operations is twice or more from the current position (i.e., the departure place) to the destination, and it is necessary to charge in each of the multiple areas, the area setting method for setting the battery charge spots and the list making method for listing the battery charge spots performed by the control unit 2 may be modified in the following manner without being restricted to the above.

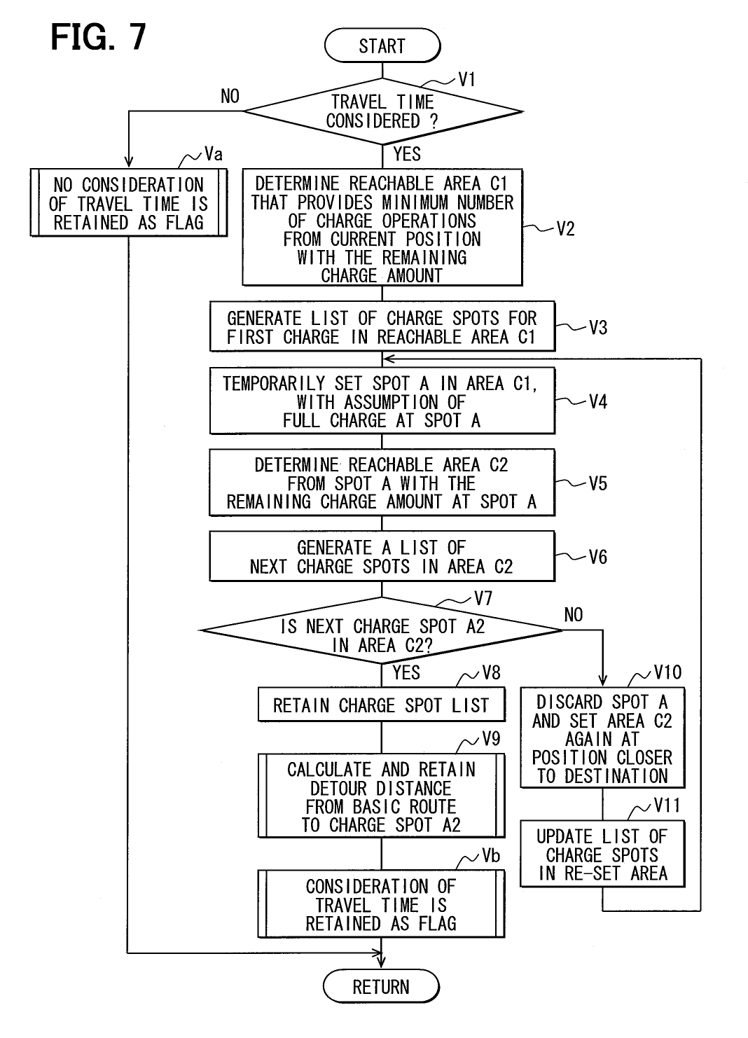

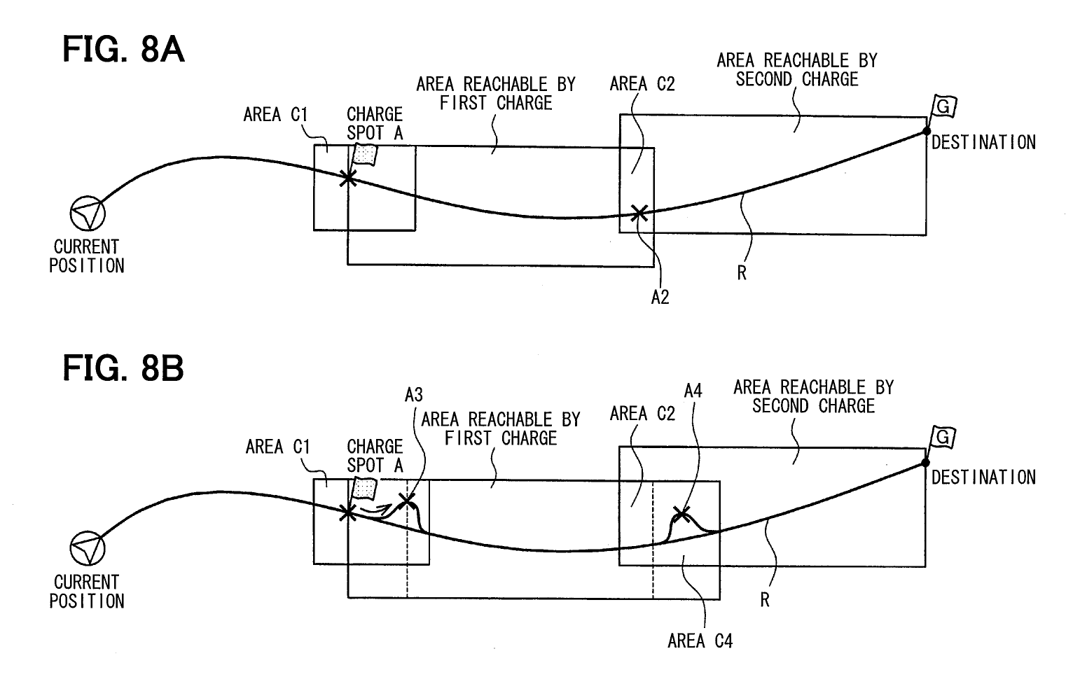

FIG. 7 is a modification example of the process that is performed by the control unit 2 at the current position (i.e., the departure place), and FIGS. 8A and 8B are the illustrations of the route. At first, when the control unit 2 considers the travel time (V1:YES) at the current position where the user sets a route, the control unit 2, calculates an area C1 (i.e., equivalent to a first departure-side area in claims), which can be reached with the fewest number of charge operations from the current position with the remaining charge amount of the battery 17 at the current position (V2), and makes a list of charge spots for the first battery charge operation in the area C1 (V3), just like the above-mentioned U2-U3.

The control unit 2 temporarily sets a charge spot in the area C1 as a charge spot A (equivalent to a first battery charge spot in claims), assuming that the charge operation at the charge spot A brings the battery 17 to a full charge (V4). The control unit 2 then determines an area that can be reached with the remaining charge amount of the battery 17 at the battery charge spot A (V5) (i.e. the reachable area with the battery 17 fully charged). In this case, an area C2 (equivalent to a first destination side area in claims), which is closer to the destination is determined by using the battery charge spot A as a start point. The area C2 is determined in the same manner as the area C1. That is, the area C2 is an area that can save/reduce the number of charge operations before arriving at the destination if the vehicle is charged in the area C2. Then, in the calculated area C2, a list of charge spots for the next battery charge operation is generated (V6).

In this case, a second battery charge spot A2 is set according to the position of the first battery charge spot A in the area C1. If the second battery charge spot A2 exists in the area C2 (V7:YES), the list made in the above is retained (V8). Then, the detour distance from a basic route R to the charge spot A2 is determined and retained (V9).

On the other hand, the next battery charge spot A2 is may not be in the area C2, which may be because the position of the second battery charge spot A2 is dependent on an actual position of the first charge spot A. Therefore, in V7, if it is determined that there is no battery charge spot in the area C2 (V7:NO), an already-determined first battery charge spot A is discarded, and the first battery charge spot A is searched for from among the positions that are closer to the destination relative to the discarded charge spot A (see a charge spot A3 in FIG. 8B, which is equivalent to a second charge spot in claims). In this case, based on the battery charge spot A3, the area C2 may be set again, or “shifted,” (V10), and the battery charge spots in area C2 (i.e., the shifted area C2) may be updated (V11), and a battery charge spot may be searched for thereafter. Then, after returning to V4, the process is repeated.

In V5, the control unit 2 calculates, as an area C3, a reachable area from the battery charge spot A3 with the full charge of the battery 17 at the spot A3, and a list of the charge spots (including, for example, a charge spot A4) in an area C4, which exists on the destination side of the area C2 (equivalent to a second destination side area in claims) is updated again. Since the battery charge spot A3 is positioned on the destination side, the area C4 is expanded toward the destination side in comparison to the area C2. Therefore, the possibility for finding the charge spot A4 in the area C4 is increased.

The above-described process is repeated until finding all of the required charge spots for the travel from the current position (i.e., the departure place) to the destination. In such manner, a non-chargeable area where the battery 17 cannot be charged will not be set. In such manner, more appropriate charge spots are guided for the user with fewer number of charge operations as possible. Further, the factor (2) can be exclusively performed without the combination with the factor (1). That is, if the user turns off the consideration setting of factor (1) in FIG. 3, only the factor (2) is performed. In such case, the control of the factor (2) is performed in consideration of the reachable area that is reachable before the remaining battery amount is decreased to zero. In such manner, the guidance that further reduces the number of charge operations can be provided.

(3) Charge Cost Consideration (Cost Consciousness)

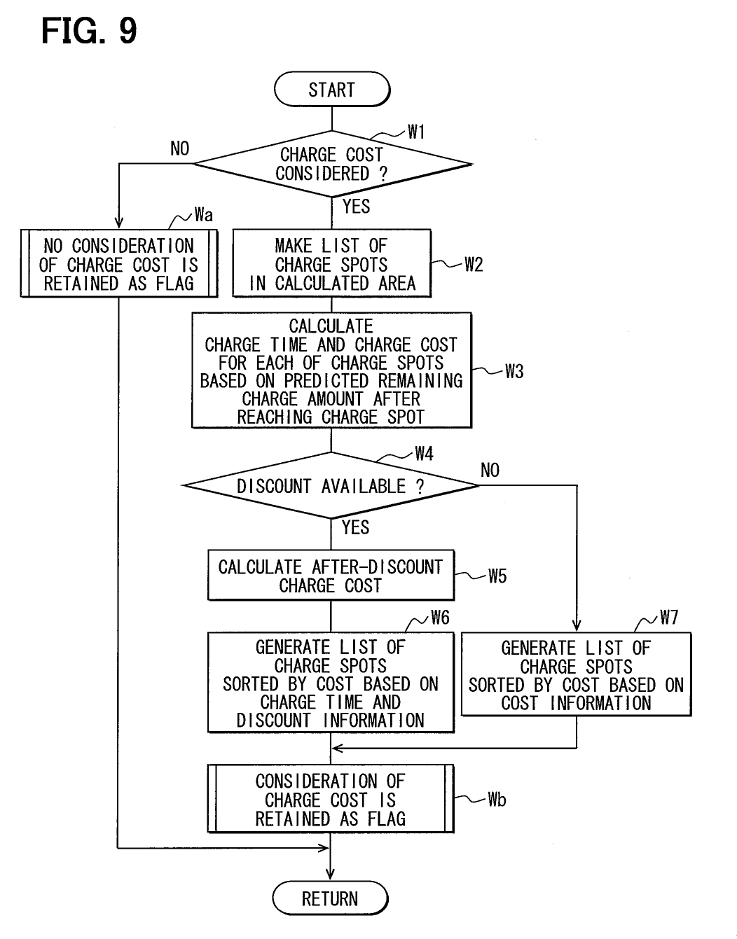

When the user values the charge cost, the following control is performed. FIG. 9 shows a control operation that is performed by the control unit 2 for considering the charge cost of the charge operation. As shown in FIG. 9, in the course of route setting by the user, the control unit 2 determines whether the charge cost is set by the user (W1), and, if consideration of the charge cost is not required (W1:NO), the control unit 2 retains as a flag (Wa) that no consideration is required for the charge cost, and returns to the main routine from the present routine. If consideration of the charge cost is required (W1:YES), W2-W7 are performed.

When the control unit 2 considers the charge cost in W1 (W1:YES), the control unit 2 calculates an area to which the vehicle can reach with the fewest number of charge operations as possible based on the remaining charge amount at the current position (i.e., the departure place). The control unit 2 makes a list of the charge spots in calculated area (W2). Based on a predicted remaining charge amount after reaching each of the charge spots from the current position, a charge time and a charge cost are calculated for each spot (W3).

At each of the charge spots, a discount coupon or the like may be available. Therefore, the control unit 2 determines whether, for example, a time-zone discount is available at each of the charge spots (W4). If the discount is available (W4:YES), such discount is subtracted from the calculated cost (W5), and a list of the charge costs is made in an ascending order of the calculated costs based on the charge time and the discount information (W6), and such list is retained in a memory. If the discount is not available (W4:NO), a list is made based on the information of the charge costs, and the list of the costs in the ascending order is retained (W7). In this case, consideration of the charge cost is kept as a flag (Wb). In such manner, the charge cost may be kept as low as possible, while providing appropriate guidance for the charge spot.

(4) Scheduled Charge Time Consideration (Time Consciousness (2))

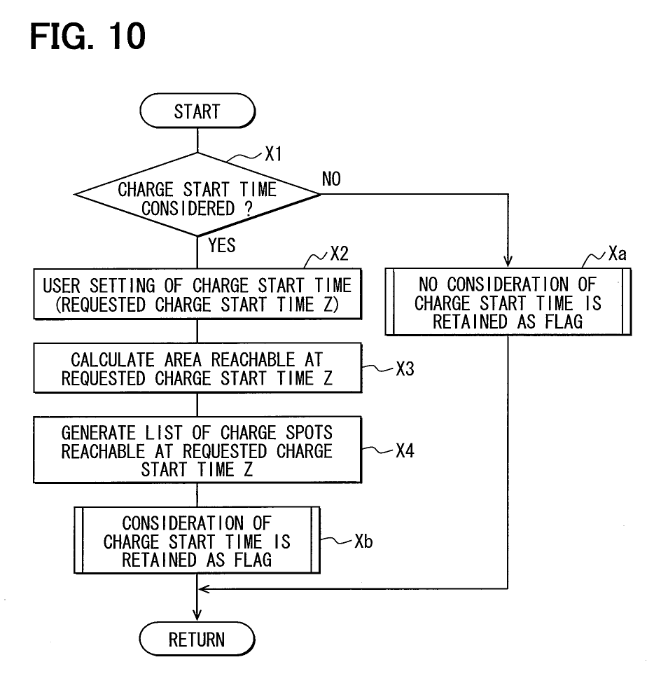

Further, there may be a case when the user would like to consider the scheduled charge time in advance. In such case, for example, the user may have to perform a task, such as dining, and would like to perform a charge operation of the battery 17 during the task. For instance, perhaps the user is dining between 12:00 pm and 1:00 pm and would like to perform a charge operation between 12:00 pm and 1:00 pm. FIG. 10 shows a control operation that is performed by the control unit 2 for considering the scheduled charge time.

When the user sets a route from the current position (i.e., the departure place) to the destination, the control unit 2 determines whether the charge start time (i.e., a scheduled charge time) is set by the user (X1). If consideration of the charge start time (i.e., a scheduled charge time) is not required (X1:NO), the control unit 2 retains as a flag (Xa) that no consideration is required for the charge start time, and returns to a main routine from the present routine. If consideration of the charge start time is required (X1:YES), X2-X4 are performed.

When the control unit 2 needs to consider the charge start time (X1:YES), the control unit 2 notifies the user to set the charge start time, thereby enabling the user to set a scheduled charge time (i.e., a requested charge start time Z). The control unit 2 then calculates an area on the basic route R at which the vehicle arrives at the requested charge start time Z (X2). Then, a list of charge spots reachable at the requested charge start time Z is made and retained (X4). In such manner, guidance to the charge spots in the calculated area is appropriately provided for the user in consideration of the scheduled charge time.

The control unit 2 of the navigation apparatus 1 recognizes the user preference shown in factors (1)-(4), which were set by the user (FIG. 3), thereby providing charge spots (i.e., charge stations) and charge timings according to the user preference. Further, the control unit 2 may monitor the amount of charge of the battery 17, and may inform the user of the charge spots in an area at which the vehicle can arrive with the remaining charge amount of the battery 17 (i.e., the charge spots in a predicted travelable range), according to the preferences or factors set by the user. In such manner, the user can choose a convenient charge spot.

For example, when the consideration setting of the battery life of factor (1) is turned on, not only the charge spots for the normal charge but also the charge spots for the quick charge may be displayed when the remaining charge amount is decreased to almost empty by the travel of the vehicle to a position close to the maxima area. The normal charge spots and the quick charge spots are preferably displayed in a distinguishable manner. This allows the user, who may usually perform the normal charge at the normal charge spot, to perform a quick charge, which may be performed for various reasons, such as charge cost, congestion at the charge spot, or an emergency. In other words, even when a little damage of the battery is expected, the quick charge may be performed. In consideration of such a situation, both the quick charge spots and the normal charge spots may be displayed, for the user's choice according to the user's convenience at the moment.

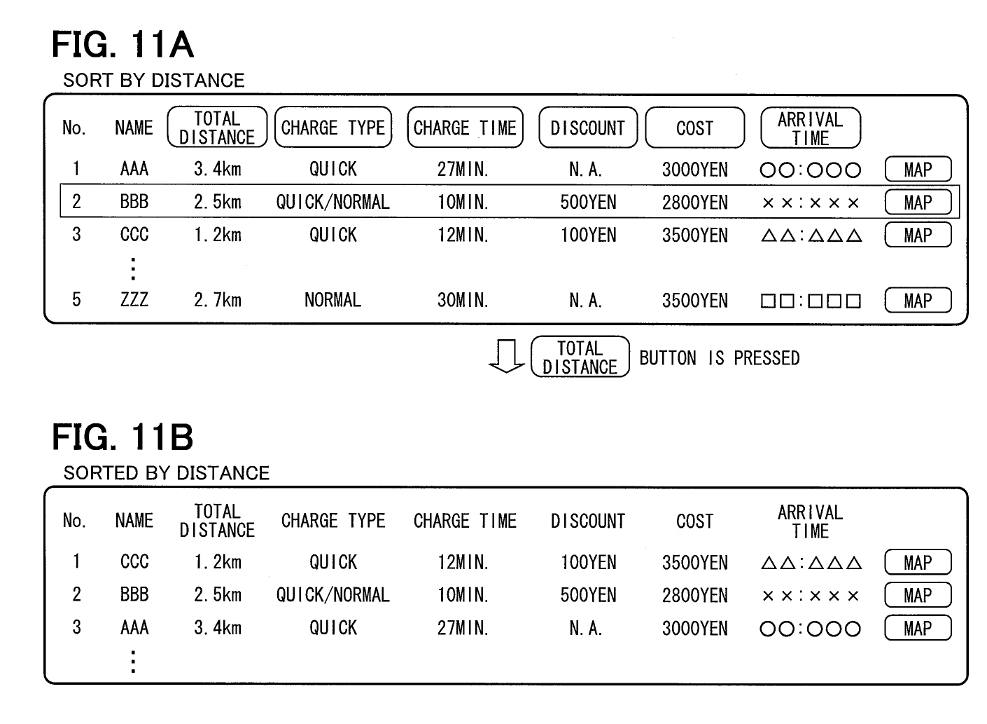

FIG. 11A and FIG. 11B show an example of a list display screen on the display unit 9 after list making for listing the charge spots. In the example shown in FIG. 11A, the display unit 9 displays charge spot information according to various headings, such as a name, a total distance, a charge type, a charge time, a discount, a cost of full charge, an arrival time. When the user presses one of the icons of a heading on the display screen of the display unit 9, the control unit 2 sorts the listed entries by using the selected heading as a sort key, for sorting the entries in an order that benefits the user.

For example, as shown in FIG. 11B, when the user touches the “total distance” icon on the screen, the control unit 2 sorts the listed entries in an ascending order of the total distance from the current position via the charge spot to the destination, for listing the entries on the display screen of the display unit 9. Thus, the user is able to easily determine the charge spot with the shortest total distance.

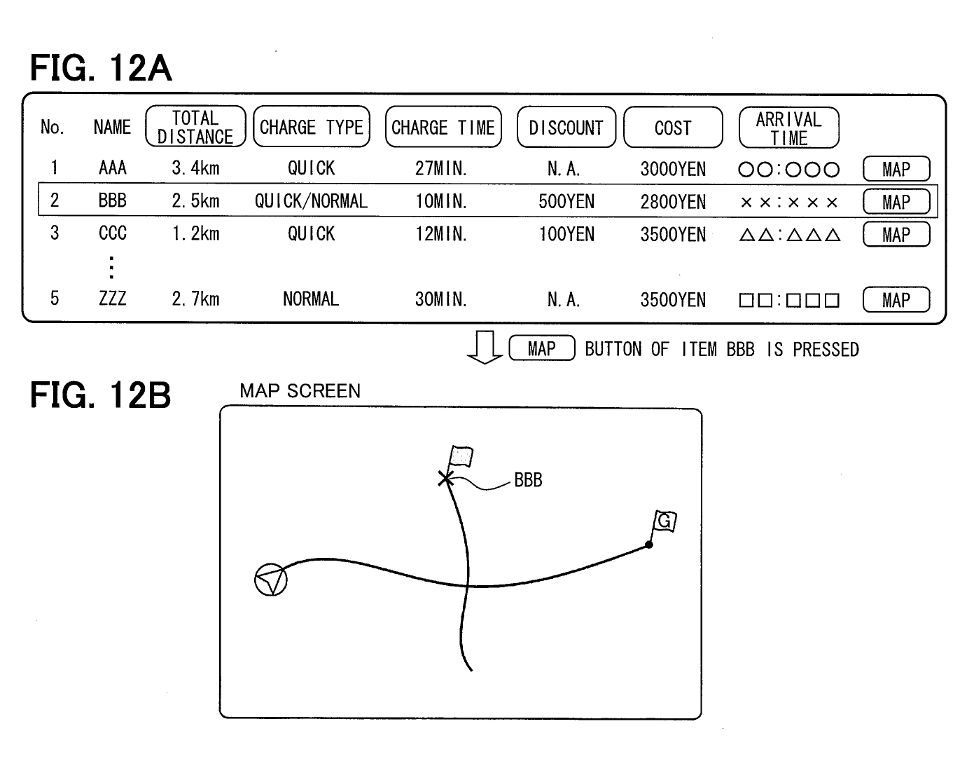

Further, FIG. 12A and FIG. 12B show an example of the map screen. In FIG. 12A, the battery charge spot information is displayed. If the user touches a “map” button of an entry of one charge spot (e.g., a charge spot BBB) for showing map information of a surrounding area of the charge spot BBB, the control unit 2 accepts an input of the “map” button through a touch panel (i.e., the operation switch group 5), and controls the screen of the display unit 9 for showing a map screen.

The display unit 9 displays a map screen that shows the battery charge spot as shown in FIG. 12B. Then, the user can confirm map information around a predetermined battery charge spot, and can confirm the place of the battery charge spot together with the routes from the current position to the destination. In such manner, the user can choose a convenient battery charge spot for him/her.

In some of the processes described above, the control unit 2 predicts at the departure place the remaining charge amount of the battery 17 when the vehicle reaches the destination from the departure place. However, the consumption of the charge amount may be affected by various factors during the travel of the vehicle along the route from the departure place to the destination. Therefore, the predicted remaining charge amount at the departure place may be different from the actual remaining charge amount during the travel of the vehicle.

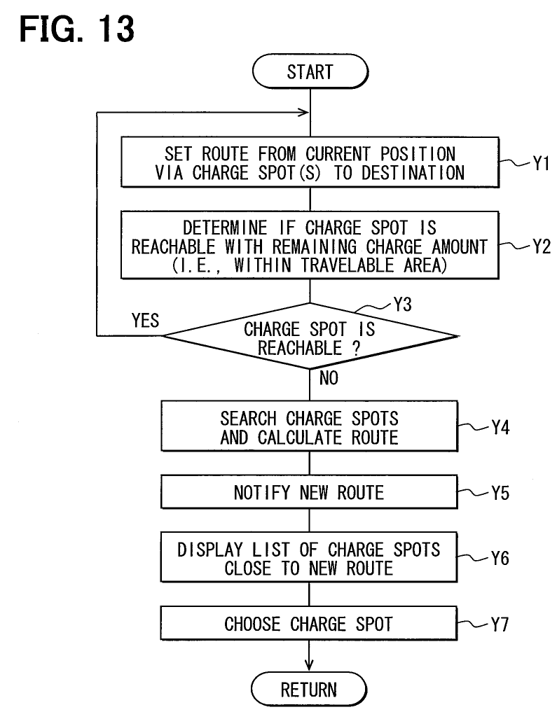

Therefore, the correctness of the predicted remaining charge amount at the departure place may be examined in real-time during the travel of the vehicle. FIG. 13 shows a flowchart of a process that determines whether the vehicle can reach the charge spot by examining the remaining charge amount in real time during the travel of the vehicle. As shown in FIG. 13, after determining a route from the current position (i.e., a departure place at the time before starting the travel of the vehicle) via the charge spot to the destination (Y1), the vehicle begins to travel. Then, it is determined whether the user can reach the charge spot based on the remaining charge amount of the battery 17 (i.e., whether the charge spot is within a travelable range) (Y2).

During the travel of the vehicle, the control unit 2 returns to Y1 if the vehicle is travelable to the charge spot, and repeats Y1 to Y3 without changing the current route. If it is determined that the remaining charge amount is not sufficient for reaching the charge spot (Y3:NO), the route is changed and re-calculated to go through a charge spot that is close to the current position within a travelable range (Y4). Then, the calculated route (i.e., a new route) is notified for the user (Y5), and a list of candidate charge spots that are close to the new route is displayed (Y6). The example of such display is same as the illustrations in FIGS. 11A-12B. Then, the user can choose one of the charge spots close to the new route (Y7).

In the present embodiment, the control unit 2 sets the area C at which the vehicle may arrive with the remaining charge amount of the battery 17 kept above a threshold that allows a quick charge when the life of the battery is being considered, and searches for a charge spot for charging the battery 17 in such area C, and provides guidance for the charge spot for charging the battery 17, which is searched for and found in the area C. Therefore, it satisfies the eco-consciousness or battery life consciousness of the user, and can appropriately provide the user with guidance for a charge spot for charging the battery 17. Further, when the user charges the battery 17 at a charge spot recommended by the control unit 2, the life of the battery 17 is extended or does not significantly decrease.

Further, when a route from the current position to the destination is searched for, the control unit 2 calculates the number of charge operations of the battery 17 during the travel on the searched route, and the number of charge operations is reduced to the minimum number by setting the multiple areas (i.e. C1 and C2) when there is more than one charge operation during the travel to the destination. In such manner, the number of charge operations of the battery 17 is reduced, thereby improving the user convenience.

Further, when the control unit 2 sets the area C1 close to the current position, the control unit 2 tries to search and find, in the area C2 that is closer to the destination, a charge spot that is reachable by the full charge of the battery 17 at the charge spot A, that is, assuming that the battery 17 is brought to full charge at the battery charge spot A in the area C1. If the control unit 2 does not find any charge spot in the area C2, the control unit 2 discards the charge spot A in the area C1, and searches for and sets a charge spot that is closer to the destination than the discarded charge spot A, and then searches for a charge spot A4 in an area C4 that is closer to the destination than the charge spot A3. Therefore, even when a charge spot could not be found in an area that is closer to the destination, the search for a charge spot is repeated until finding one. As a result, the non-chargeable area where the vehicle's battery cannot be charged will not be set on a route between the departure place and the destination.

Further, the control unit 2 searches for a battery charge spot in a maxima area where the remaining amount of the battery 17 is reduced to empty, and provides for the user a list of searched charge spots together with the above-described normal charge spots. Therefore, the user can choose a convenient battery charge spot from among the listed spots.

Further, after determining the route from the departure place to the destination via the charge spots, the control unit 2 examines in real time during the travel of the vehicle whether the next battery charge spot is reachable by a remaining charge amount, which is being monitored in real-time. If it is determined that the next spot is not reachable, the control unit 2 determines a news route and searches for a reachable charge spot. In such manner, a reachable battery charge spot will be searched for again and a zero charge level of the battery 17 is prevented as the vehicle is traveling towards the destination.

Further, the control unit 2 calculates the cost of full charge at the battery charge spot based on a predicted remaining battery amount at the battery charge spot, and the calculated costs are listed on the screen of the display unit 9, thereby allowing the user to recognize the cost of full charge. The calculated cost may be the cost of a full charge, or may be the cost of charge to a predetermined charge level according to the user input, that is, to the charge level of, for example, 80%.

Further, the control unit 2 controls the display unit 9 to display a charge cost list that reflects a discount whenever such discount is available. Therefore, the user can recognize the discount information of the charge costs.

Further, the control unit 2 controls the display unit 9 to display the charge cost list for showing charge time information together with the charge costs at each of the charge spots. Therefore, the user can recognize the charge time of each of the charge spots.

### Second Embodiment

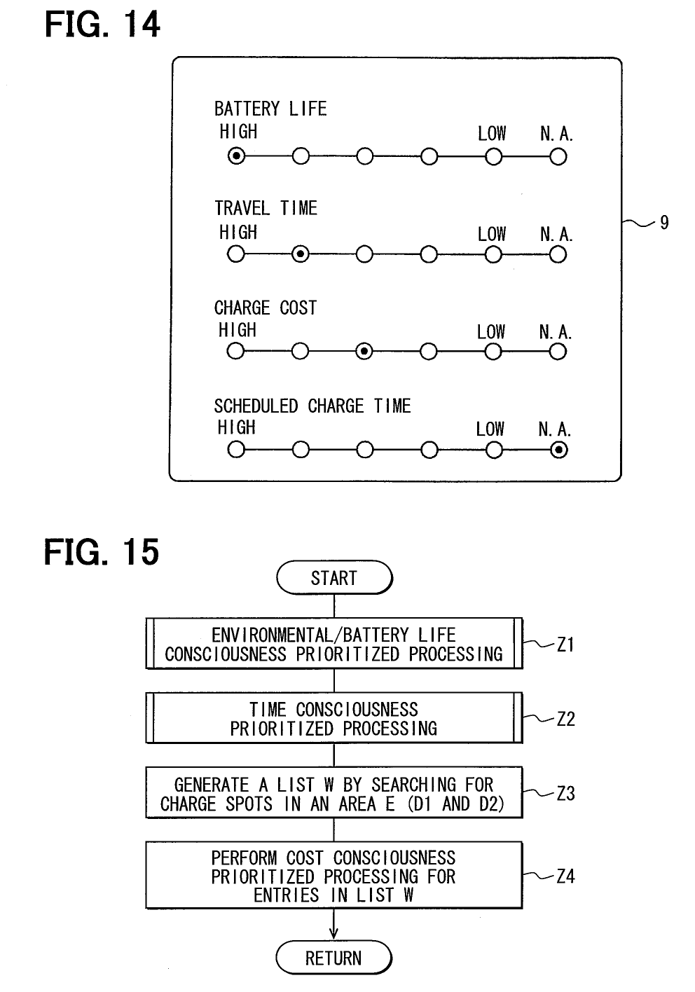

FIG. 14-FIG. 16 illustrate the second embodiment of the present disclosure, which is different from the first embodiment in that the user preference has a priority level for each the factors, and the priority level set by the user are used to calculate the area of the charge spots. In the following, like parts have like numbers just like the previous embodiment.

In the previous embodiment, various factors are set to be either considered or not, and the charge area is set according to the setting of the factor. In the present embodiment, each factor has a priority level, and the priority level setting is reflected to the area of the charge spots, for narrowing the scope of the area as required.

FIG. 14 shows a priority setting interface of the factors that are establish a user's preference. The control unit 2 controls, as shown in FIG. 14, the display unit 9 to display the interface on the screen for allowing the user to selectively set a priority level of each of factors: battery life (environmental/battery life consciousness), travel time (time consciousness (1)), charge cost priority levels (cost consciousness), and scheduled charge time (time consciousness (2)). The user uses the operation switch group 5 to input a priority level of each factor. In such manner, the user can set a priority of each factor.

For example, the user sets the priority level for the battery life at highest level (i.e. first priority), sets the priority level for travel time at the second highest level, and sets the priority level for charge cost at the third highest level. In such manner, the navigation apparatus 1 can recognize the user's preference, and can recommend a charge spot according to the prioritized factors.

FIG. 15 shows a flowchart of a process performed by the control unit 2 for handling the priority level. As illustrated, the process first performs environmental/battery life consciousness prioritized processing in Z1, then performs a step of time consciousness prioritized processing in Z2, and then makes in Z3 a list W of charge spots in an area E that is calculated by an “AND” operation of an area D1 from Z1 and an area D2 from Z2, and then performs a step of cost consciousness processing for the entries in the list W in Z4.

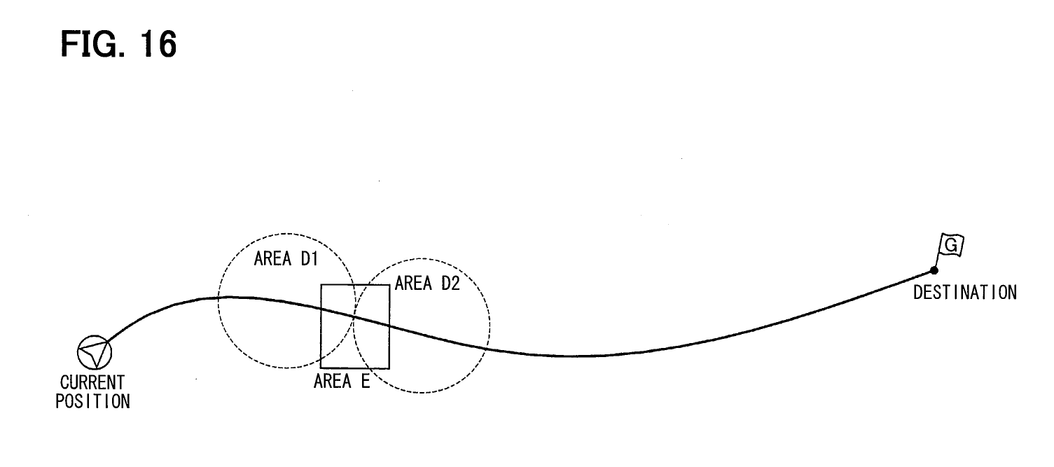

FIG. 16 shows an illustration of a situation. When the control unit 2 prioritizes the battery life in the area setting, it tends to set the area D1 to be closer to the current position (i.e., the departure place) than the destination. When the control unit 2 prioritizes the travel time in the area setting, it tends to set the area D2 to be closer to the destination than the area D1. Therefore, the control unit 2 sets the area E as an intermediate area of both of these areas D1 and D2, and makes the list W of the charge spots in area E. The area E may be determined in the following manner. That is, when the area D1 and the area D2 overlap with each other, the overlapping area may, for example, be set as the area E. Further, for example, in case that the area D1 and the area D2 do not overlap, the area E may be set as an area that includes a part of the area D1 and a part of the area D2. Further, for example, when the area E includes both of the areas D1 and D2, the area E may have a D1 portion set to have a greater area than a D2 portion, according to the factor having the highest priority level, which is provided as battery life in this example.

The control unit 2 then performs in Z4 a cost prioritized processing for the list W. By displaying a sorted list of charge spots in the area E on the display unit 9, which is sorted in an ascending order (i.e., in an order of cost from low to high), the user can recognize charge spots in a list form which best serve his/her needs and preferences.

In the present embodiment, the control unit 2 sets multiple areas D1 and D2, which are in accordance with the priority level of the factors defining a user's preference, and provides for the user guidance to the area E that is in between multiple areas (i.e., the area D1 and the area D2). Therefore, the user can recognize charge spots in a list form which best serve his/her needs and preferences.

### Third Embodiment

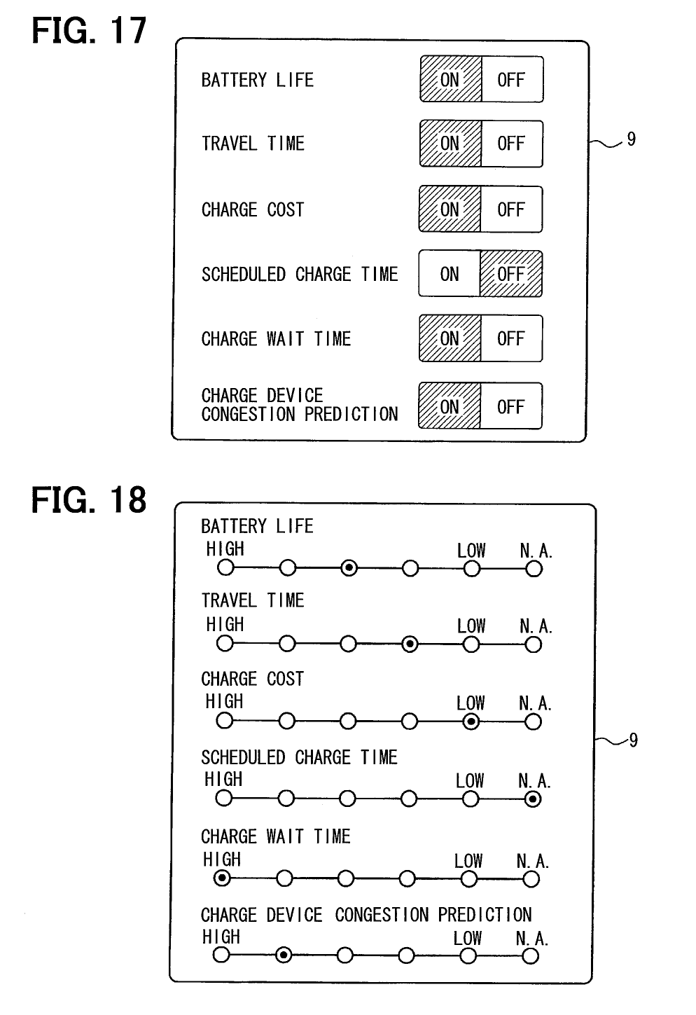

FIG. 17-FIG. 32 shows the third embodiment of the present disclosure, which considers additional factors for searching and finding charge spots and charge timing. That is, in addition to the above described factors (1)-(4), other factors may be taken into consideration. As described in the second embodiment, like parts have like numbers, and description of the like parts is omitted for brevity.

In the present embodiment, two additional factors are added.

(5) Charge wait time consideration (Time consciousness (3))

(6) Charge device/spot congestion prediction consideration

In regards to factor (4), the user may set a scheduled charge time, for charging the battery 17 during a break at a service area or the like. However, the full charge of the vehicle may take a considerable amount of time. Therefore, at the time of departure from the service area, the charge may still not be sufficient. In such case, the user may need to wait to bring the vehicle to the full charge. Factor (5) provides for a charge wait time as a factor that may be set by the user.

In addition, in regards to factor (6), the number of battery charge devices is still limited in public places, such as a highway, or a major/local road. Therefore, the user may have to wait after arriving at a charge spot to charge the battery 17. In such case, factor (6) may be used to acquire the availability of charge devices at a charge spot, and to take into consideration the congestion of the charge spot (e.g., vacancy or availability of charge devices).

With reference to FIG. 17, the control unit 2 may provide factors (5), (6) in addition to factors (1)-(4) in the initial setting screen on the display unit 9, for letting the user set from ON/OFF through the touch panel (the operation switch group 5) the factors important to the user. Based on settings of the factors (1)-(6), the navigation apparatus 1 can provide suitable battery charge spots and charge timings.

Further, with reference to FIG. 18, a priority level setting is provided through the display unit 9, and the user may set respective priority levels to be stored in the control unit 2. In the following, the priority level settings of the factors (5) and (6) are described.

(5) Charge Wait Time Consideration (Time Consciousness (3))

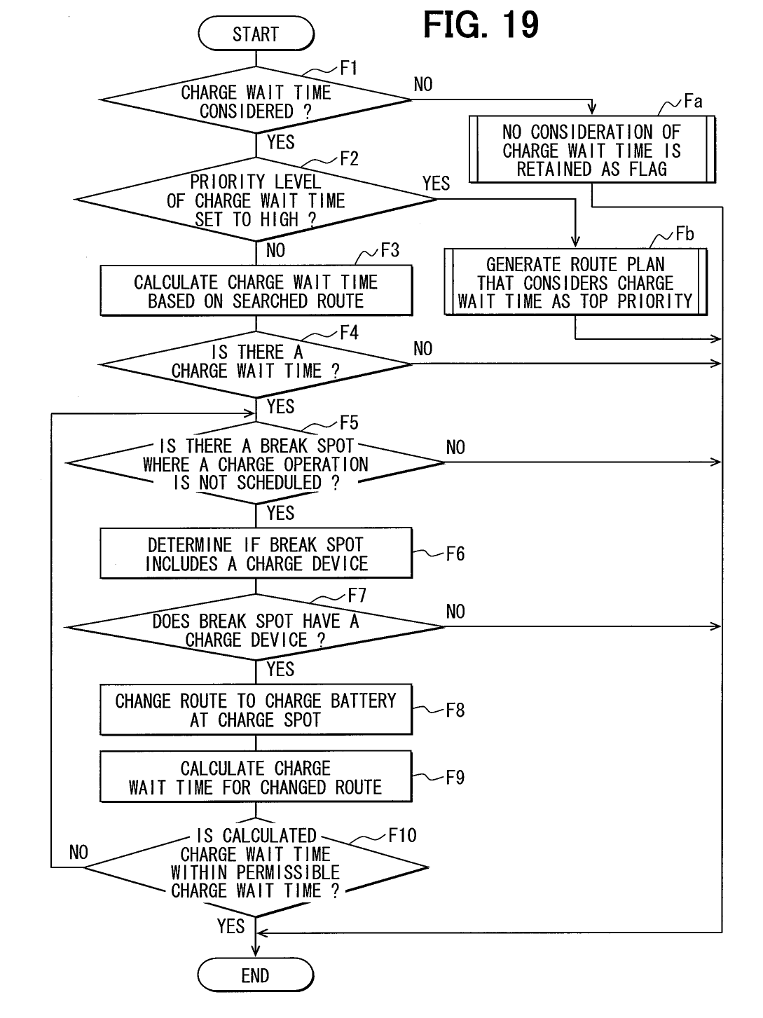

The user may feel like shortening the charge wait time, and thus the charge wait time may have a high priority level. In FIG. 19, a control operation with consideration of the charge wait is provided.

The control unit 2 determines whether the user preference is set to consider the charge wait time (F1). If no consideration of the charge wait time is required (F1:NO), no consideration of the charge wait time is retained as a flag (Fa), and the process is finished. If the consideration of the charge wait time is required (F1:YES), F2-F10 are performed.

In F2, if the priority level of the charge wait time is set to “high” (FIG. 18) (F2:YES), the control unit 2 makes a route plan that considers the charge wait time as a top priority, which serves as a search result (Fb).

If the priority of the charge wait time is set to a relatively low level (F2:NO), that is, not the top priority, the control unit 2 performs F3-F10.

In F3, the control unit 2 considers the factors that have a higher priority than the charge wait time to search for a route (i.e., the basic route) from the current position to the destination by the Dijkstra method, and calculates the charge wait time based on the searched route.

The charge wait time is calculated according to the desired period of time the user would like to have a break at a service area, a parking area, a sightseeing place and the like. The desired period of time of the break is set by the user in advance, and is stored in a memory of the control unit 2. The desired period of time may also be pre-stored in the nonvolatile memory of the control unit 2 as a default value (i.e., an initial value) at a production stage of the navigation apparatus 1.

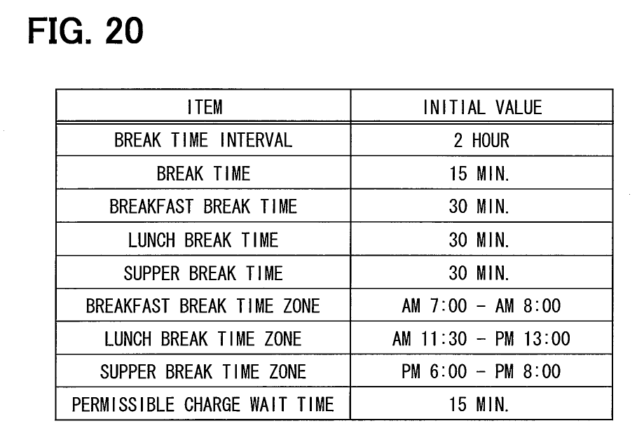

FIG. 20 shows various settings of break time and the like. The control unit 2 calculates the charge wait time using the information of the break time and the like shown in FIG. 20. The settings in FIG. 20 include “Break time interval,” “Break time,” “Breakfast break time,” “Lunch break time,” “Supper break time,” “Breakfast break time zone,” “Lunch break time zone,” “Supper break time zone,” and “Permissible charge wait time.” These time lengths and time zones may be set as a rough reference value by the user. The term “time zone” is used to refer to a time period during the day (i.e. 24 hours) in which a certain activity may take place or typically takes place. For example, the lunch break time zone is provided between 11:30 and 13:00 (1:00 pm) (FIG. 20) because that is the time period in which a lunch break is most commonly taken. Such time zones may also be set by the user.

The “Break time interval” is, for example, an interval between a breakfast break and a lunch break, and/or an interval between a lunch break and a supper break. “Break time” is a user-desired time length of the break, which is the time length of a break in a time zone other than the breakfast break time zone, the lunch break time zone, the supper break time zone. “Breakfast break time” is a user-desired time length of the break in the breakfast break time zone. “Lunch break time” is a user-desired time length of the break in the lunch break time zone. “Supper break time” is a user-desired time length of the break in the supper break time zone. “Breakfast break time zone,” “Lunch break time zone,” and “Supper break time zone” in FIG. 20 may also be respectively set by the user. “Permissible charge wait time” is an allowable (i.e. permissible) period of time that the user may wait for the charge operation of the battery 17.

With reference to the settings of the break times set by the user or the pre-stored settings, the control unit 2 can calculate “the charge wait time” in F3 as the time length of battery charging minus the time length of the break. That is, the charge wait time is the period of time the user is waiting for only the charge operation of the battery 17. If the charge wait time is zero (F4:NO), the process of FIG. 19 returns to a main routine. In other words, the control unit 2 retains the route that is set in F3. On the other hand, when the charge wait time is longer than the permissible charge wait time, that is, not satisfying the user preference setting (F4:YES), F5-F10 are performed to reduce the charge wait time.

In F5, the control unit 2 determines whether there are multiple break spots on the current route, and determines whether there is a break spot where a charge operation of the battery 17 is not scheduled. When a break spot without a scheduled charge operation is found, the control unit 2 refers to the center device 18 through the communications equipment 7, for determining whether a battery charge device is installed at such break spot (F6). The center device 18 accumulates such information in a database, and the control unit 2 acquires the information of installation of the charge device in the break spot through transmission of information from the center device 18 to the control unit 2.

If a charge device is not installed in the break spot where a charge operation of the battery 17 is not scheduled (F7:NO), the process of FIG. 19 is returned to a main routine. If a break spot having a charge device exists (F7:YES), the route is changed to use such break spot (i.e., the break spot where a charge operation was originally not planned) for charging the battery 17, for the amount of charge made by the charge wait time (F8), which may otherwise be decreased. In other words, the charge wait time at a certain charge spot is re-allocated to other charge spot(s) where a charge operation was not originally planned.

The control unit 2 then calculates the charge wait time for the changed route (F9), and determines whether the calculated charge wait time is shorter than the permissible charge wait time, which is acceptable for the user (F10). The control unit 2 repeats F5-F9 until the charge wait time becomes shorter than the permissible charge wait time (F10:YES), to find an optimum route that satisfies the condition of F10.

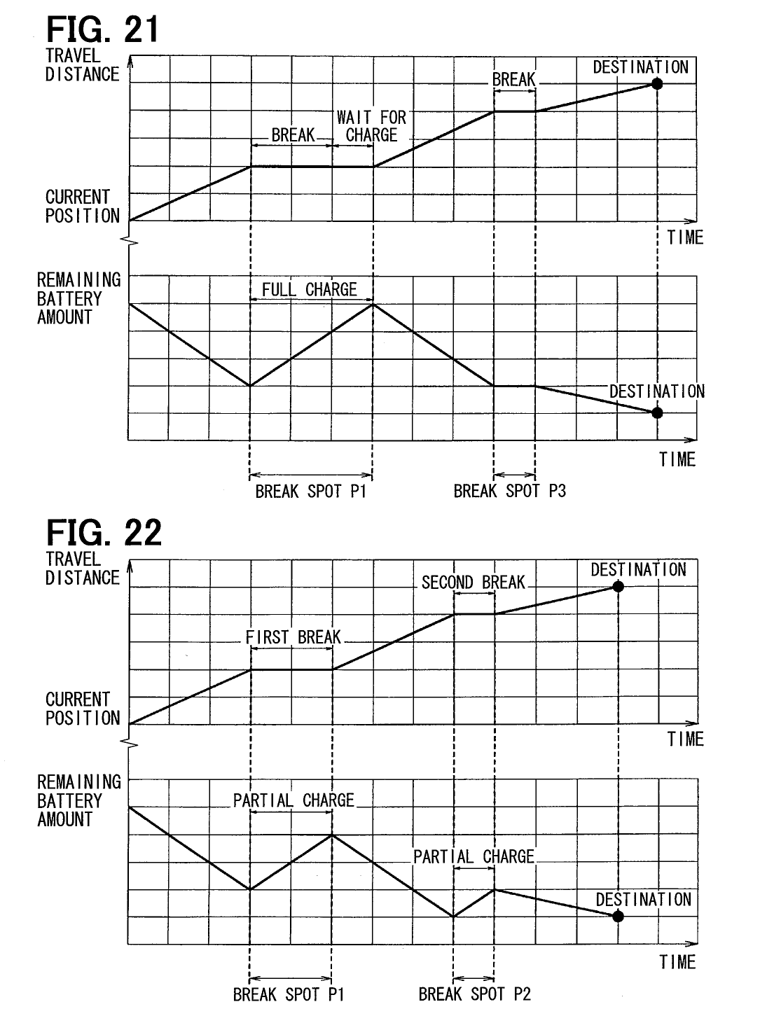

The graph in FIG. 21 show time-wise transition of the travel distance and the remaining charge amount of a route plan that has a considerable amount of charge wait time.

The control unit 2 searches for a route in consideration of the priority levels in the above-mentioned F3, and generates a route plan that requires multiple (i.e., more than one) breaks, for example, at break spots P1, P3 between the current position and the destination, among which the break at the spot P1 is scheduled to bring the battery to full charge, which is an assumption. If such a route plan is used, the user needs to wait for the full charge of the battery at the first break spot P1 (i.e. there is a charge wait time at the break spot P1). Therefore, the charge wait time for the full charge of the battery is longer than the permissible charge wait time, which may be inconvenient for the user.

With reference to FIG. 22, the control unit 2 searches for a break spot P2 that has no scheduled charging from among the break spots between the current position and the destination in F5 of FIG. 19, and, in F6, confirms if the spot P2 has the charge device through a query to the center device 18. If the spot P2 has the charge device (F7:YES), the control unit 2 replaces the spot P3 with the spot P2 as the break spot in F8. Then, the control unit 2 changes the route plan to the one that charges the battery by using the charge device at the break spots P1 and P2, and still maintains a minimum number of charge operations to 2.

If the route plan (i.e., scheduled travel route and predicted remaining charge amount) illustrated in FIG. 21 is used, the charging of the battery 17 will not be performed at the third break spot P3. On the other hand, if the route plan (i.e., scheduled travel route and predicted remaining charging amount) illustrated in FIG. 22 is used, the battery is partially charged at the first break spot P1, and then the battery is partially charged again at the second break spot P2. In this case, the user can charge the battery during the break time at the break spot P2, and the user need not wait for the full charge of the battery 17 at the break spot P1. In such manner, the user's preference of not waiting for a charger operation to complete is satisfied while reducing the travel time to the destination.

FIG. 22 show an example of a charge operation at the second break spot P2, which charges the battery for a time length of the charge wait time at the break spot P1 in the original route plan. However, the charge time at the second break spot P2 may be extended than the above example, to an extent that the charge operation at the second break spot P2 is within the permissible charge wait time. In such manner, the charge amount of the battery at the second break spot P2 can be increased.

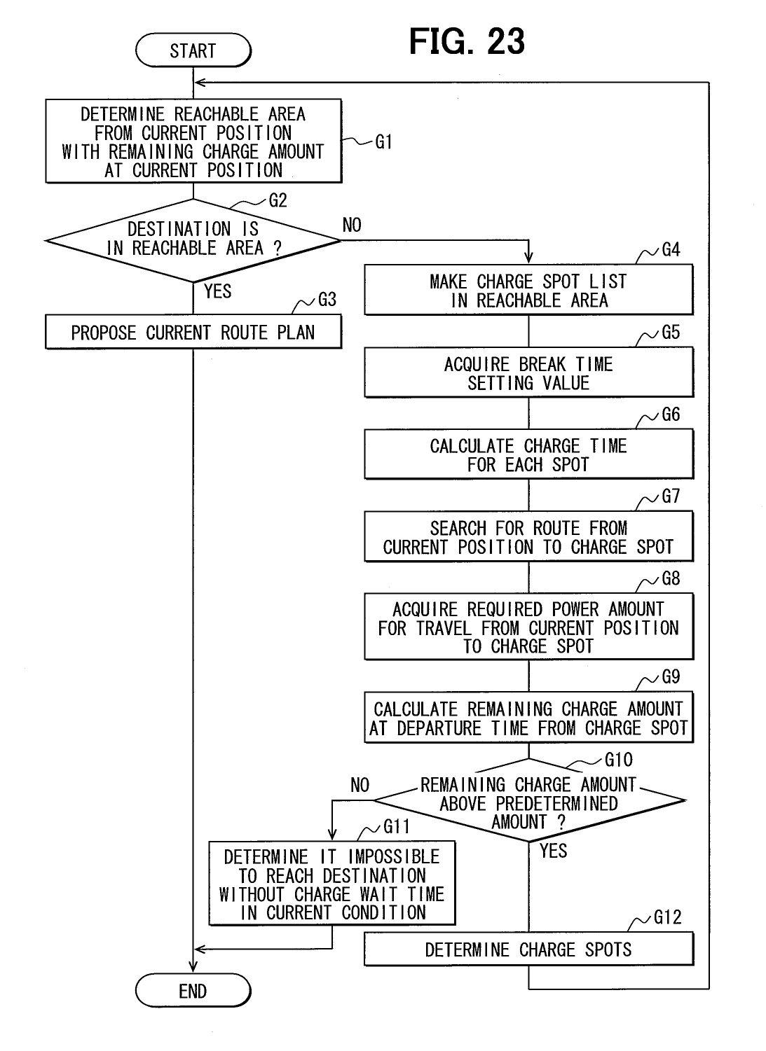

In the following, a process for planning a route where the charge wait time is provided as a high priority (F2: YES; Fb) is described with reference to FIG. 23.

In the course of planning a route that prioritizes the charge wait time, the control unit 2, in G1, determines a reachable area that the vehicle is able to travel to with the remaining charge amount from the current position. In this case, the reachable area may be an area reached by the vehicle with the driving power source (i.e., the battery 17) where the battery 17 has a remaining charge amount above the required charge threshold X (i.e., a quick charge recommend threshold) when the vehicle reaches the reachable area, or may be an area reached by the vehicle where the battery 17 has a remaining charge amount of almost zero.

The control unit 2, in G2, determines whether the destination is in the reachable area, and if the destination is in the reachable area (G2:YES), the current route plan from the current position to the destination is proposed (G3) without any changes/modifications. If the destination is not in the reachable area when the control unit 2 calculates the reachable area in G1 (G2:NO), G4-G12 are performed.

The control unit 2 generates a list of battery charge spots in the reachable area (G4), and acquires the predicted break time for each of the charge spots in the list (G5). In G5, the control unit 2 calculates an arrival time at each of the break spots by acquiring distance information from the current position to each break spot, determines to what time zone (i.e., a breakfast break time zone, a lunch break time zone, a supper break time zone) the calculated arrival time corresponds, and acquires the setting value of corresponding time zone.

Then, the control unit 2 calculates the charge time at each of the charge spots based on the information of the charge spots, break time setting values, the remaining charge amount of the battery 17 at the current position (G6), and chooses a farthest-possible battery charge spot that is farthest from the current position, and searches for a route from the current position to the chosen charge spot (G7). Choosing the farthest-possible battery charge spot may reduce the number of charge operations from the current position to the destination.

Thereafter, the control unit 2 acquires information of a required amount of power (i.e., electricity), which is required for the travel of the vehicle from the current position to the charge spot, through communication from the communication equipment 7 to the center device 18 (G8). The center device 18 calculates the required amount of electricity according to various information, and transmits the calculated amount to the control unit 2. Then, the control unit 2 calculates a remaining charge amount at the time of departure from the battery charge spot (G9). The remaining charge amount at the time of departure from the battery charge spot is calculated by subtracting, from the remaining charge amount at the current position, the required amount of electricity, and then by adding, to the result of the above subtraction, the charge amount provided by the charge operation for the time period of the permissible charge wait time.

Then, the control unit 2 determines whether the remaining charge amount is above a predetermined amount, that is, above an amount that allows the vehicle to reach the next charge spot, or above the quick charge recommend amount after arriving at the next charge spot (G10). If the remaining charge amount is under the predetermined amount (G10:NO), that is, if the amount is not sufficient for reaching the next charge spot, or if the amount is not sufficient as the quick charge recommend amount, it is determined that it is currently impossible to reach the destination without having a charge wait time that exceeds the permissible charge wait time (G11), and returns to a main routine. In such case, the user may be notified about the current situation, prompting him/her to change the condition settings, for example.

Further, in G10, even when a condition that the remaining charge amount is above a predetermined amount is not satisfied (G10:NO), the break spot having the second highest priority, that is, the second nearest break spot from the destination, may be selected from among the multiple break spots in the reachable area, for example, for returning to G7 and repeating G7-G11.

If the control unit 2 determines in G11 that, even after the above process, the destination is not reachable without having the charge wait time, a route having the charge wait time needs to be searched for. Therefore, for example, the route is searched for in F3 of FIG. 19 in consideration of the other conditions having a high priority level, and, by repeating F4-F10, the searched route(s) having the charge wait time may be output.

On the other hand, if it is determined that the remaining charge amount is above the predetermined amount and is sufficient for reaching the next charge spot, or is sufficient as the quick charge recommend amount for maintaining battery life (G10:YES), the above-assumed charge spot is determined as a waypoint (G12), and returns the process to G1 for repeating the calculation of the reachable area from the battery charge spot determined in G12 and for repeating the process.

Until the control unit 2 determines that the destination is in the reachable area from the determined battery charge spot (G2:YES), it repeats the process of G4-G12. In such manner, all the charge spots between the current position and the destination are determined, and a route passing the user-desired charge spots can be searched for.

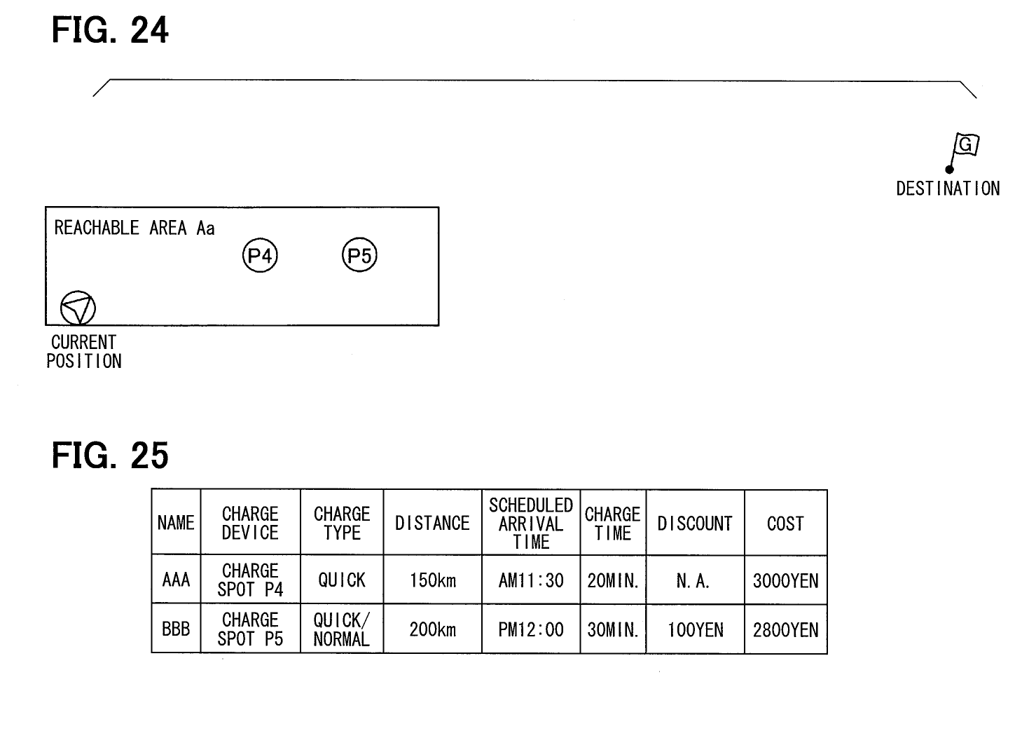

The situation is described in a more practical manner in the following. FIG. 24 shows an illustration including a reachable area Aa calculated in G1 of FIG. 23 and the charge spots (i.e., the break spots) P4, P5 in the reachable area Aa. Then, the control unit 2 makes, in G4, a list of battery charge spots in the reachable area Aa (i.e., a list of charge devices in each of the break spots P4, P5) as shown in FIG. 25. The contents of this list are substantially same as the one in FIG. 11A, listing a type of the charge device, a distance from the current position, a charge time, amount of discount, a charge cost, a scheduled arrival time, and the like. The scheduled arrival time may be calculated based on the information, such as an along-the-way distance from the current position, an average speed, and a current time. Such information may be derived from the information from various sensors by the control unit 2.

Then, the control unit 2 in G6 of FIG. 23 chooses, in a first cycle of the process in FIG. 23, a far spot P5 that is far from the current position than the spot P4 for reducing the number of charge operations, since both of the break spots P4, P5 is capable of quick charging. The control unit 2 then sets the length of the break time according to the time zone. If the break time is scheduled in the “lunch break time zone,” for example, the time length of 30 minutes is set for the break time, and such break time is entirely planned as the charge time.

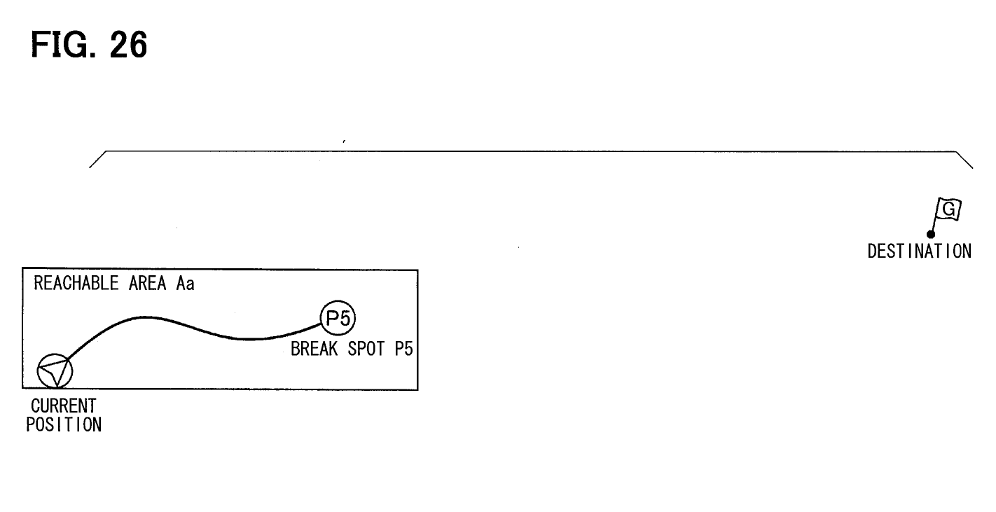

Then, the control unit 2 sets the spot P5 as a break spot in G7 as shown in FIG. 26, and searches for a route from the current position to the spot P5. Then, the control unit 2 calculates a required power amount in G8 for the travel from the current position to the spot P5, and calculates the remaining charge amount at the time of departure from the spot P5 in G9.

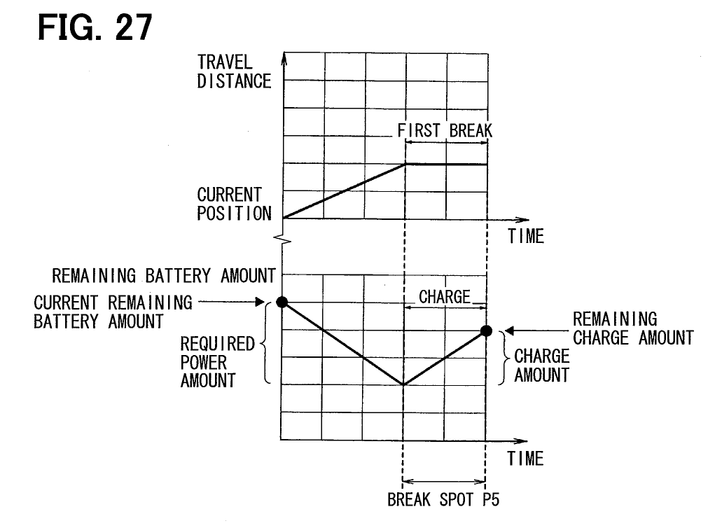

The control unit 2 can calculate the remaining charge amount at the time of departure from the spot P5 as shown in FIG. 27, by subtracting the required power amount calculated in G8 from the remaining charge amount at the current position, and by adding the amount of charge for 30 minutes at the spot P5. If it is determined in G10 that the calculated amount is above the predetermined amount, and is sufficient for reaching the next charge spot, which may be in an area Ab having break spots P6, P7 included therein, the spot P5 is determined as a waypoint in G12, and the process is repeated from G1 that calculates the reachable area. Such process is repeated until finding the destination in the reachable area.

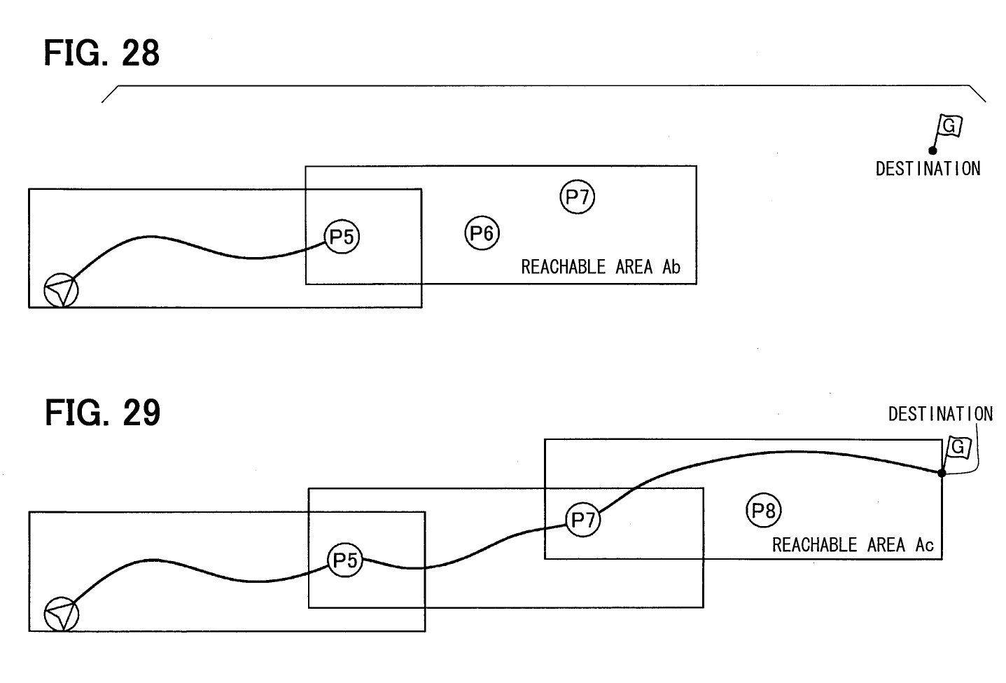

Therefore, as shown in FIG. 28, if the battery charge spots P6, P7 are included in the next reachable area Ab of the spot P5, the spot P7 closer to the destination is determined as the waypoint. Finally, as shown in FIG. 29, if the destination is included in the next reachable area Ac of the spot P7, a search process for searching for a subsequent reachable area after the area Ac will not be performed. Then, this route plan, routing from the current position through the waypoints P5 and P7 to the destination, is proposed.

According to the present embodiment, when (i) the spots P4, P5 which can charge the battery 17 is searched for in the reachable area Aa, (ii) the preset break time that is set for the spot P5 is assumed as the charge time of the spot P5, (iii) the remaining charge amount at the time of departure from the spot P5 is calculated by subtracting the required power amount for the travel to the spot P5 from the remaining charge amount at the current position, and by adding the amount of charge for the time length of the charge operation at the spot P5, and (iv) the calculated remaining charge amount is equal to or greater than the predetermined amount, the spot P5 is determined as the waypoint.

In such manner, the user is enabled to charge the battery with his/her needs and preferences satisfied as much as possible. Further, since the remaining charge amount of the battery is kept above a certain amount, the load of the battery is reduced and the battery life is extended.

(6) Charge Device Congestion Prediction Consideration

The user may feel like avoiding the idle time due to the congestion of the charge device in the break spot, and thus the charge start time for starting the use of the charge device may have a high priority level.

The control unit 2 determines whether the user preference setting considers a charge start wait time. If it is determined that consideration of the charge start wait time is required, the control unit 2 acquires, after searching for a route, information regarding the congestion prediction, the charge start wait time, and the like from the center device 18. The center device 18 calculates such information and transmits such information to the control unit 2.

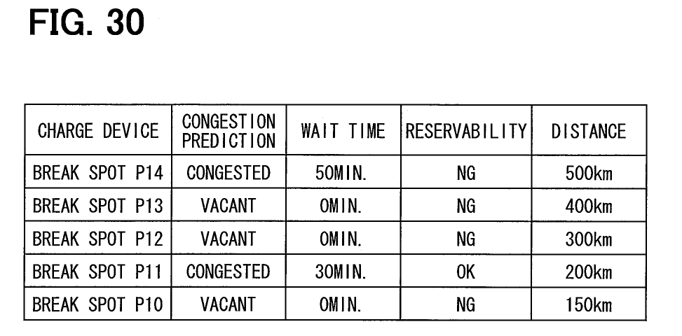

FIG. 30 shows a table of congestion prediction and the like for each of the break spots, which the control unit 2 acquires from the center device 18. As shown in FIG. 30, the center device 18 accumulates, in a database, congestion prediction information at the moment, the charge start wait time of the charge device in the charge spot, the reservability of the charge device, distance information, and the like, for each of the break spots P10-P14, and provides such information for the control unit 2 on demand.

The above-mentioned congestion prediction information may be congestion prediction information at the scheduled arrival time of the vehicle to each of the spots P10-P14, and, in response to the transmission of the scheduled arrival time from the control unit 2, the center device 18 may provide the congestion prediction information at the scheduled arrival time for the control unit 2. Further, the distance information may be calculated by the control unit 2 of the navigation apparatus 1. The control unit 2 may determine which one of the spots P10-P14 is used as the break spot based on such information.

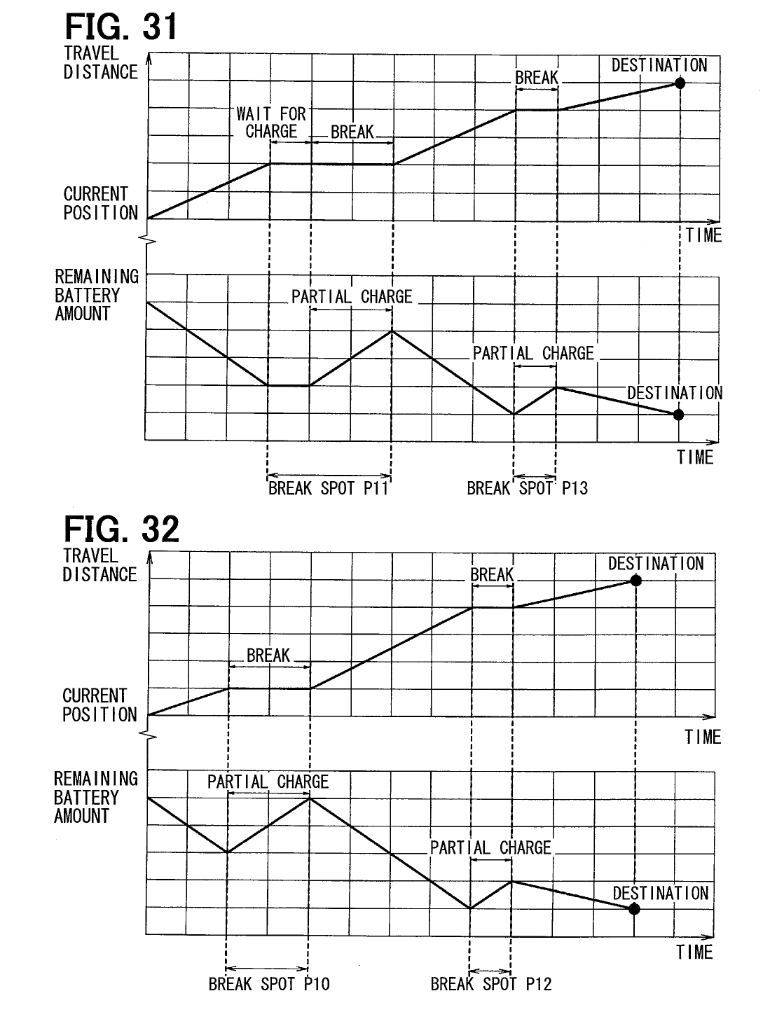

FIG. 31 shows an example of the time-wise transition of the travel distance and the remaining amount of the battery. When the control unit 2 acquires information of the “congested” condition of the spot P11 in FIG. 30, the user needs to have a charge start wait time before using the charge device after arriving at the spot P11 as shown in FIG. 31. If the charge start wait time is longer then the permissible charge wait time set by the user, it is very likely that the user must wait for a long time, which is inconvenient for the user.

Therefore, the control unit 2 uses the spot P10, which is in the same area as the spot P11, as the break spot, instead of using the spot P11. In such case, since the charge device in the spot P10 is “vacant” as indicated by the congestion prediction information in FIG. 30, the user will not likely have any wait time before charging.

FIG. 32 shows an example of the time-wise transition of the travel distance and the remaining charge amount when the spot P10 is used as the break spot. As shown in FIG. 32, there is no charge start wait time. If there is no charge start wait time, the travel time for the travel from the current position to the destination is reduced.

Further, for example, the control unit 2 on the navigation apparatus 1 side may set a charge reservation, if necessary, based on the reservability information of the charge device installed in each of the spots P10-P14 provided by the center device 18. In such manner, the reservation of the charge device in the spot P11 may be made during the travel of the vehicle to the destination or at the current vehicle position, thereby reducing/diminishing the charge start wait time after arriving at the spot P11.

As described above, when a charge spot (i.e., a break spot) is searched for and is found, a different charge spot (i.e., a break spot) P10 that is different from the searched spot P11 is searched for after determining that the searched spot P11 is congested. Alternatively, after determining whether the charge start wait time of the searched spot (i.e., a break spot) P11 exceeds the permissible charge wait time, a different charge spot is searched for in case that the charge start wait time is greater than the permissible charge wait time. In this manner, the user can reduce the charge start wait time as much as possible.

The control unit 2 makes a charge reservation based on the reservability information of the charge device at the charge spot. Therefore, even if the charge spot is crowded at the time of making the charge reservation of the charge device, the charge of the battery may be started smoothly upon arrival of the vehicle at the charge spot if the congestion of the charge device is resolved by the time of arrival of the vehicle. In such manner, the user-desired condition of the charge operation is satisfied as much as possible.

According to the present embodiment, the charge wait time, including the charge start wait time, of the user is reduced as much as possible, and the charge wait time is reduced by partially charging the battery multiple times before arriving at the destination. Therefore, the travel time to the destination is reduced. Further, due to the charge operation during the break time of the user, the break time of the user will not be wasted.

### Other Embodiments

Although the present invention has been fully described in connection with the preferred embodiment thereof with reference to the accompanying drawings, it is to be noted that various changes and modifications will become apparent to those skilled in the art.

For example, when the vehicle travels with its battery not fully charged, the battery may be emptied if the vehicle is caught in a traffic congestion.

Therefore, the control unit 2 of the navigation apparatus 1 may propose a route plan for a user, after acquiring, from the center device 18, a required power amount of a route that takes the predicted traffic congestion into consideration.

The present disclosure may be applicable to a case that has multiple charge devices in each of the break spots P1-P7. Though the control unit 2 acquires various information from the center device 18 in the above embodiment, such information may also be calculated independently on the control unit 2 side. Further, a part or an element of such information may be acquired from the center device 18, and the acquired information may be processed to serve as required information.

In the above embodiments, the control unit 2 of the vehicular navigation apparatus 1 corresponds to each of various units in claims. That is, the control unit 2 corresponds to a first area setting unit, a battery charge spot search unit, a battery charge spot guidance unit, a route search unit, a charge count unit, a determination unit, a re-search unit, a second area setting unit, a third area setting unit, a cost calculation unit, a notification control unit, and a reservation unit, or, more practically, realizes the function of each of those units in the present disclosure.

Alternatively, replacing such embodiment, one of (a) the center device 18 external to the vehicle in communication with the communications equipment 7 and (b) other vehicular control device connected to the control unit 2 in the vehicle through an in-vehicle LAN (not illustrated) may realize (i) at least a part/element of the function of each of those units in the present disclosure or (ii) at least a part/element of the function of at least a part/element of each of those units in the present disclosure, and calculation/operation results of one of (α) the center device 18 and (β) other vehicular control device may be utilized to realize each of those units or the function of each of those units in the present disclosure, or calculation/operation results may be transmitted from the one of the center device 18 and other vehicular control device to the control unit 2 as required to realize each of those units or the function of each of those units in the present disclosure.

Further, the full charge in claims indicates that the battery is brought to a condition of storing a physically maximum amount of electricity. Instead, the full charge may indicate that the battery is brought to a condition of storing a limit charge amount of electricity according to a user setting or according to a specification of the vehicle, which is smaller than the maximum amount described above. The setting of the limit charge amount according to the specification of the vehicle prevents the battery from being excessively worn out due to the storage of the maximum amount of electricity.

Such changes and modifications are to be understood as being within the scope of the present invention as defined by the appended claims.

What is claimed is:

1. A vehicular navigation apparatus comprising:
a first area setting unit setting a reachable area that is reachable by a vehicle, wherein a battery of the vehicle has a remaining charge amount at least equal to a quick charge threshold in the reachable area;
a battery charge spot search unit searching for a battery charge spot in the reachable area determined by the first area setting unit; and
a battery charge spot guidance unit guiding the vehicle to the battery charge spot provided by the search unit.

2. The vehicular navigation apparatus of claim 1 further comprising:
a route finding unit determining a route to a destination from a departure place; and
a charge count unit determining a number of battery charge operations required along the route, wherein when the number of battery charge operations along the route determined by the charge count unit is greater than one, the first area setting unit sets a plurality of reachable areas to minimize the number of battery charge operations.

3. The vehicular navigation apparatus of claim 2, wherein,
when the first area setting unit determines a first battery charge spot in a first departure-side reachable area, the first area setting unit sets a first destination-side reachable area as a next reachable area that is reachable when the battery is fully charged at the first battery charge spot, and
when the battery charge spot search unit determines that a battery charge spot is not found in the first destination-side reachable area, the first area setting unit assumes a full charge of the battery at a second battery charge spot that is on a destination side of the first battery charge spot in the first departure-side area and repeats an area setting process for setting a second destination-side reachable area on a destination side of the second battery charge spot, the second destination-side reachable area replacing the first destination-side reachable area.

4. The vehicular navigation apparatus of claim 1, further comprising:
a determination unit determining in real time whether a battery charge spot is reachable by consuming a remaining charge amount of the battery while the vehicle is traveling and after determining the route via the battery charge spot from a departure place to a destination; and
a search repeat unit re-calculating the route and searching for a battery charge spot when the battery charge spot is determined as un-reachable.

5. The vehicular navigation apparatus of claim 1, further comprising:
a second area setting unit setting a maxima area where the vehicle is reachable with the remaining charge amount of the battery is substantially zero, wherein
the battery charge spot search unit searches for a battery charge spot in the maxima area that is set by the second area setting unit, and
the battery charge spot guidance unit guides the vehicle to each of the battery charge spots that are searched for by the battery charge spot search unit and that exist in the areas respectively set by the first and second area setting units.

6. The vehicular navigation apparatus of claim 1, wherein
the battery charge spot search unit searches for a battery charge spot, and temporarily sets a pre-defined value of a break time for the battery charge spot to be used as a permissible wait time at the battery charge spot,
the permissible wait time is compared with a full charge time of the battery charge spot that brings the battery to a full charge to determine whether the full charge time at the battery charge spot exceeds the permissible wait time at the battery charge spot, and
when the full charge time exceeds the permissible wait time, the battery charge spot search unit searches for a different battery charge spot.

7. The vehicular navigation apparatus of claim 1, wherein
the battery charge spot search unit temporarily sets a pre-defined value of a break time that is pre-defined for a battery charge spot to be used as a pre-defined charge time at the battery charge spot,
the battery charge spot search unit calculates a departing charge amount of the battery at a time of departure from the battery charge spot by (i) subtracting, from the remaining charge amount, a required power amount for a travel of the vehicle to the battery charge spot and (ii) adding, a charge amount received during the pre-defined charge time at the battery charge spot, and
when the departing charge amount at the time of departure from the battery charge spot is equal to or greater than a predetermined amount, the battery charge spot is set as a next battery charge spot.

8. The vehicular navigation apparatus of claim 1, wherein
the battery charge spot search unit searches for a battery charge spot, and determines whether the battery charge spot is congested, and
when the battery charge spot is determined as congested, the battery charge spot search unit searches for a different battery charge spot.

9. The vehicular navigation apparatus of claim 1, wherein
the battery charge spot search unit searches for a battery charge spot, and determines whether a charge start wait time of the battery charge spot exceeds a predetermined value of a permissible wait time, and
when the charge start wait time is determined as exceeding the permissible wait time, the battery charge spot search unit searches for a different battery charge spot.

10. The vehicular navigation apparatus of claim 1 further comprising:
a reserve unit making a charge reservation by utilizing reservation information of a charge device of a battery charge spot that is provided by the battery charge spot search unit.

11. The vehicular navigation apparatus of claim 1 further comprising:
a third area setting unit setting an intermediate reachable area that is in middle of a plurality of reachable areas according to a priority of user preference, wherein
the first area setting unit sets, as departure-side reachable areas and as destination-side reachable areas, a plurality of area candidates according to a priority level of user preference,
the third area setting unit sets the intermediate reachable area of the plurality of area candidates when the plurality of area candidate are set by the first area setting unit,
the battery charge spot search unit searches for a battery charge spot in the intermediate reachable area set by the third area setting unit, and
the battery charge spot guidance unit guides the vehicle to the battery charge spot in the intermediate reachable area.

12. The vehicular navigation apparatus of claim 1 further comprising:
a cost calculation unit calculating a cost of charging the battery at respective battery charge spots based on an expected remaining charge amount of the battery at a time of arriving at respective battery charge spots; and
a notification control unit controlling a notification unit to present a list of full charge costs at respective battery charge spots.

13. The vehicular navigation apparatus of claim 12, wherein the notification control unit controls the notification unit to present discount information of the cost in the list of full charge costs when a discount is available for the cost calculated by the cost calculation unit.

14. The vehicular navigation apparatus of claim 12, wherein the notification control unit controls the notification unit to present charge time information of respective battery charge spots in a list that shows correspondence between the battery charge spot and the cost.
